(19) United States
(12) Patent Application Publication
(10) Pub. No.: US 2025/0063472 A1
(43) Pub. Date: Feb. 20, 2025

(54) SETUP AND TEARDOWN FOR RELAY OPERATION IN WI-FI NETWORKS

(71) Applicant: Samsung Electronics Co., Ltd., Suwon-si (KR)

(72) Inventors: Peshal Nayak, Plano, TX (US); Boon Loong Ng, Plano, TX (US); Bilal Sadiq, Plano, TX (US); Matthew Tonnemacher, Plano, TX (US); Yue Qi, Plano, TX (US); Rubayet Shafin, Frisco, TX (US); Vishnu Vardhan Ratnam, Frisco, TX (US); Elliot Jen, Taipei City (TW)

(21) Appl. No.: 18/803,064

(22) Filed: Aug. 13, 2024

Related U.S. Application Data
(60) Provisional application No. 63/533,467, filed on Aug. 18, 2023.
(60) Provisional application No. 63/535,237, filed on Aug. 29, 2023.
(60) Provisional application No. 63/544,546, filed on Oct. 17, 2023.

(51) Int. Cl. H04W 48/10; H04L 5/00; H04W 76/15

(52) U.S. Cl. CPC H04W 48/10; H04L 5/0048; H04W 76/15

(57) ABSTRACT

Methods and apparatuses for setup, management and use of relay devices in a wireless local area network. A relay device includes a transceiver and a processor operably connected to the transceiver. The transceiver is configured to form a first link with a wireless access point (AP) and a second link with a wireless non-AP station (STA). The processor is configured to determine to perform a relay control action comprising (i) setup of a relay connection by which the relay device will relay traffic between the AP and the STA over the first and second links, (ii) teardown of the relay connection, or (iii) advertisement of a capability of the relay device to support the relay connection, and to generate a control message including an indication of the relay control action. The transceiver is further configured to transmit, to at least one of the AP and the STA, the generated control message.

### CROSS-REFERENCE TO RELATED APPLICATIONS AND CLAIM OF PRIORITY

This application claims priority under 35 U.S.C. § 119(e) to U.S. Provisional Patent Application No. 63/533,467 filed on Aug. 18, 2023, U.S. Provisional Patent Application No. 63/535,237 filed on Aug. 29, 2023, and U.S. Provisional Patent Application No. 63/544,546 filed on Oct. 17, 2023, which are hereby incorporated by reference in their entirety.

### TECHNICAL FIELD

This disclosure relates generally to wireless communications systems that include relay devices. Embodiments of this disclosure relate to methods and apparatuses that facilitate setup, management, and use of relay devices for relaying traffic between other devices in a wireless local area network communications system.

### BACKGROUND

Wireless local area network (WLAN) technology allows devices to access the internet in the 2.4 gigahertz (GHz), 5 GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The IEEE ultra-high reliability study group (UHR SG), which is the study group for next generation WI-FI standards design, e.g., IEEE 802.11bn, has set a number of objectives for next generation WI-FI network design. The group intends to achieve the ultra-high reliability target by reducing latencies to ultra-low values, increasing throughputs at different signal-to-noise ratio (SNR) levels, enhancing power savings, etc. To meet these objectives, the group intends to develop new protocols and concepts for performance improvement compared to WI-FI 7.

Next generation extremely high throughput (EHT) WI-FI systems, e.g., IEEE 802.11be, support multiple bands of operation, called links, over which an access point (AP) and a non-AP device can communicate with each other. Thus, both the AP and non-AP device may be capable of communicating on different bands/links, which is referred to as multi-link operation (MLO). The WI-FI devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA). With bandwidth aggregation across multiple channels/bands, MLO offers significant gain in throughput and latency performance compared to single link operation in the previous generation (802.11ax).

### SUMMARY

Embodiments of the present disclosure provide methods and apparatuses that facilitate setup, management, and use of relay devices for relaying traffic between other devices in a WLAN.

In one embodiment, a wireless relay device is provided, comprising a transceiver and a processor operably connected to the transceiver. The transceiver is configured to form a first link with a wireless AP and a second link with a wireless non-AP STA. The processor is configured to determine to perform a relay control action comprising (i) setup of a relay connection by which the relay device will relay traffic between the AP and the STA over the first and second links, (ii) teardown of the relay connection, or (iii) advertisement of a capability of the relay device to support the relay connection, and to generate a control message including an indication of the relay control action. The transceiver is further configured to transmit, to at least one of the AP and the STA, the generated control message.

In another embodiment, a method of wireless communication performed by wireless communication relay device is provided. The method includes the steps of: determining to perform a relay control action comprising (i) setup of a relay connection by which the relay device will relay traffic between a wireless access point (AP) and a wireless non-AP station (STA) over a first link with the AP and a second link with the STA, (ii) teardown of the relay connection, or (iii) advertisement of a capability of the relay device to support the relay connection, generating a control message including an indication of the relay control action, and transmitting, to at least one of the AP and the STA, the generated control message.

In another embodiment, a wireless AP is provided, comprising a transceiver and a processor operably coupled to the transceiver. The transceiver is configured to form a link with a wireless communication relay device and receive, from the relay device, a control message including an indication of a relay control action. The processor is configured to determine, from the control message, that the relay control action is one of (i) setup of a relay connection by which the relay device will relay traffic between the AP and a wireless non-AP station (STA) over the link, (ii) teardown of the relay connection, or (iii) advertisement of a capability of the relay device to support the relay connection.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of. A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The following documents are incorporated by reference herein in their entirety:
[1] IEEE P802.11be/D4.0, 2024.
[2] IEEE Std 802.11-2020.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example scenario for use of a WI-FI relay according to embodiments of the present disclosure;

FIG. 4 illustrates an example element format according to embodiments of the present disclosure;

FIG. 5 illustrates an example setup control field format of an element according to embodiments of the present disclosure;

FIG. 6 illustrates an example control frame format according to embodiments of the present disclosure;

FIG. 7 illustrates an example relay setup control field format of a control frame according to embodiments of the present disclosure;

FIG. 8 illustrates an example relay setup information field format of a control frame according to embodiments of the present disclosure;

FIG. 9 illustrates an example element format according to embodiments of the present disclosure;

FIG. 10 illustrates an example response control field format of an element according to embodiments of the present disclosure;

FIG. 11 illustrates an example control frame format according to embodiments of the present disclosure;

FIG. 12 illustrates an example relay setup response control field format of a control frame according to embodiments of the present disclosure;

FIG. 13 illustrates an example relay setup response information field format of a control frame according to embodiments of the present disclosure;

FIG. 14 illustrates an example relay setup procedure initiated by the STA with the AP according to embodiments of the present disclosure;

FIG. 15 illustrates an example relay setup procedure initiated by the STA with the relay according to embodiments of the present disclosure;

FIG. 16 illustrates another example relay setup procedure initiated by the STA with the relay according to embodiments of the present disclosure;

FIG. 17 illustrates an example relay setup procedure initiated by the AP with the relay according to embodiments of the present disclosure;

FIG. 18 illustrates an example element format according to embodiments of the present disclosure;

FIG. 19 illustrates an example control frame format according to embodiments of the present disclosure;

FIG. 20 illustrates an example relay teardown response information field format of a control frame according to embodiments of the present disclosure;

FIG. 21 illustrates an example discovery request procedure according to embodiments of the present disclosure;

FIG. 22 illustrates an example discovery response procedure according to embodiments of the present disclosure;

FIG. 23 illustrates an example relay assisted AP discovery procedure according to embodiments of the present disclosure;

FIG. 24 illustrates another example relay assisted AP discovery procedure according to embodiments of the present disclosure;

FIG. 25 illustrates another example relay assisted AP discovery procedure when no APs are found according to embodiments of the present disclosure;

FIG. 26 illustrates an example association assistance request procedure according to embodiments of the present disclosure;

FIG. 27 illustrates an example association assistance request message handling procedure according to embodiments of the present disclosure;

FIG. 28 illustrates an example association response status message procedure according to embodiments of the present disclosure;

FIG. 29 illustrates an example relay assisted AP association procedure according to embodiments of the present disclosure;

FIG. 30 illustrates an example relay assisted AP discovery and association procedure according to embodiments of the present disclosure;

FIG. 31 illustrates another example relay assisted AP discovery and association procedure according to embodiments of the present disclosure;

FIG. 32 illustrates another example relay assisted AP discovery and association procedure according to embodiments of the present disclosure;

FIG. 33 illustrates an example procedure for handling reachable AP information according to embodiments of the present disclosure;

FIG. 34 illustrates an example operation for reachable AP advertisement according to embodiments of the present disclosure; and

FIG. 35 illustrates an example process for setup, management, and use of relay devices for relaying traffic between other devices according to various embodiments of the present disclosure.

### DETAILED DESCRIPTION

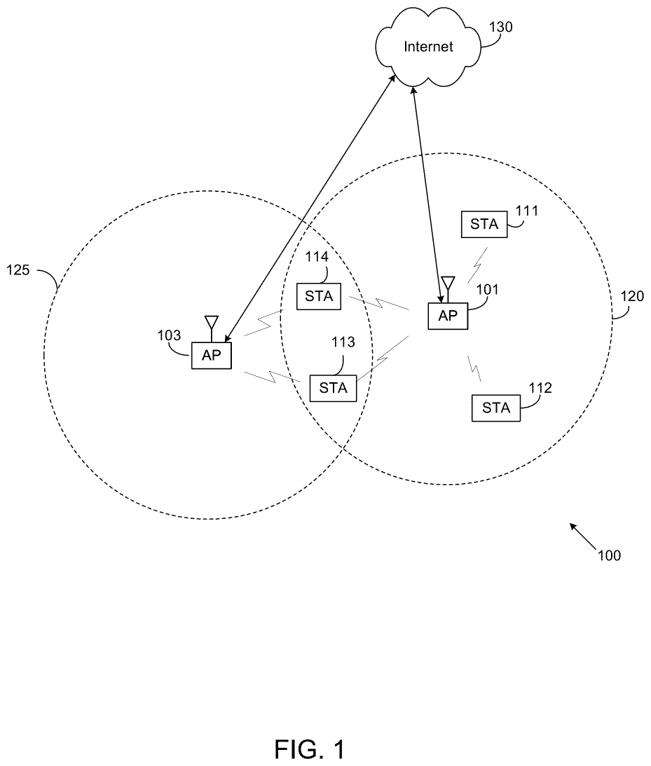

FIGS. 1 through 35, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that one of the objectives of UHR is to increase the range of wireless connectivity of an AP so that users (non-AP devices) can get connectivity in areas where the AP signal is weak or not available at all. A relay device can be used to support this functionality. A relay can act as an intermediate node that can forward packets received from the AP to a non-AP. Embodiments of the present disclosure further recognize that a setup procedure is needed by which the relay can set up a connection with the AP. In the same manner, a setup procedure to set up a connection between the relay and the endpoint user device is also needed. Similarly, a procedure to tear down the relay operation is needed.

Accordingly, embodiments of the present disclosure provide a number of solutions for handling relay discovery, setup, and operation. These embodiments include setup procedures and corresponding signaling, teardown procedures and corresponding signaling, and capability advertisement procedures and signaling.

Embodiments of the present disclosure additionally recognize that in order for the STA to perform communication, it is important to perform a setup with the AP. However, since the STA can be outside the range of the AP or unable to transmit frames directly to the AP, the STA may not be able to perform any kind of communication setup with the AP (e.g., discovery of AP, association with the AP, etc.). Consequently, procedures such as the following are needed: A procedure for relay assisted discovery of the AP, which can enable the STA to discover APs that are out of its range but can be communicated with using relay operation. A procedure for relay assisted association with the AP, which can enable the STA to associate with APs that are out of its range but can be associated with using the relay's help.

Additionally, embodiments of the present disclosure recognize that the STA may need to disassociate with the current AP while outside of the communication range of the AP. For instance, the STA can move to a different location and may need to perform a handover to a different AP. Thus, the STA may want to disassociate with the old AP. To enable this a relay based disassociation procedure is necessary.

Accordingly, embodiments of the present disclosure provide a number of solutions for handling relay assisted AP association for STAs. These embodiments include relay assisted discovery/probing procedures and necessary signaling, relay assisted scanning procedures and necessary signaling, relay assisted association procedures and necessary signaling, some example conditions in which a STA can seek assistance from a relay for association, reachable AP information handling procedures, and relay assisted disassociation procedures and necessary signaling.

Embodiments of the present disclosure additionally recognize that when the traffic of a STA is relayed, the intermediate relay device may not be informed about the timing information and delay constraints related to the frames that are being relayed. For instance, the AP may know the expiration time of the downlink frames based on the delay tolerance and enqueue timestamp, however, the relay may not have such an estimation based on the information available at the relay. Consequently, the relay may not be able to appropriately prioritize STAs based on their transmission/reception urgency. A procedure to inform the relay about the timing information of the relayed frames can be beneficial for efficient relay operation.

Accordingly, embodiments of the present disclosure provide a number of solutions for handling timing information exchange for relay operations. These embodiments include a procedure for timing information exchange and corresponding signaling and device behavior, a negotiation procedure for timing information exchange and corresponding signaling and device behavior, and an advertisement procedure for timing information exchange.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

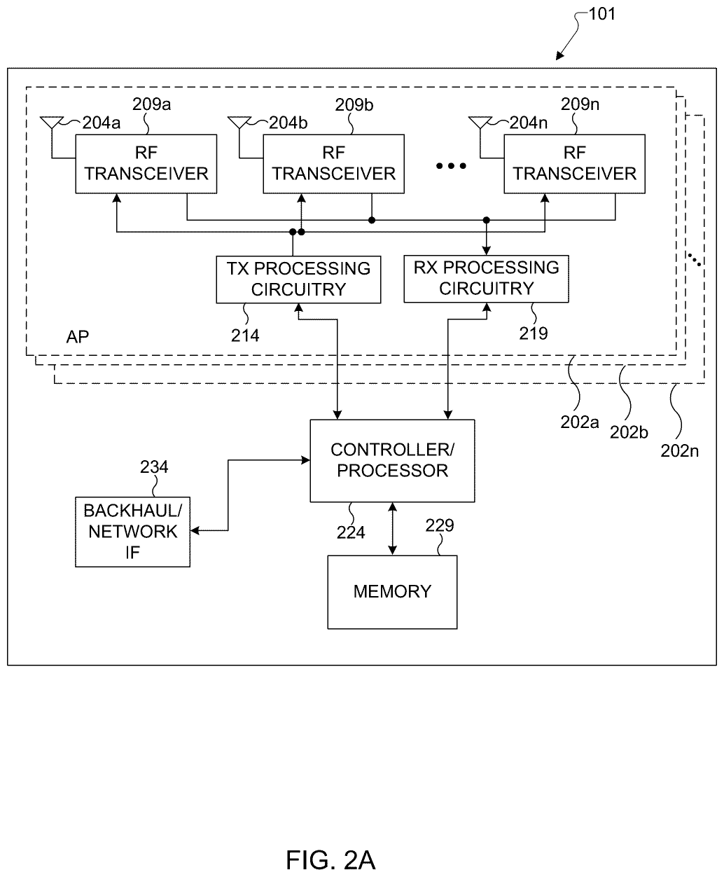

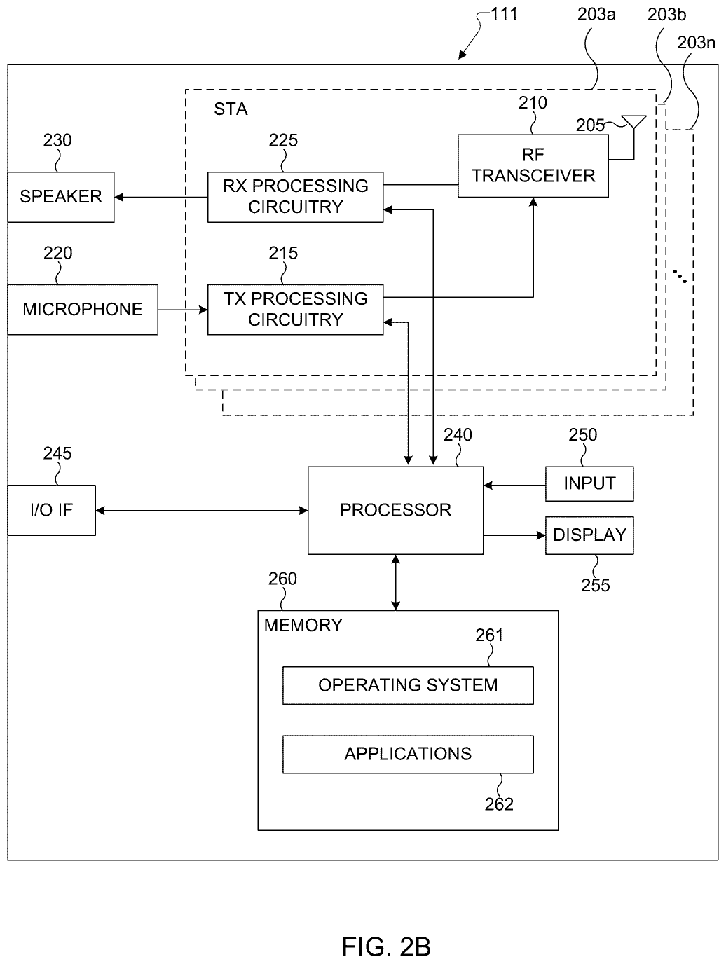

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connections. For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antennas 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antennas 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antennas 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate setup, management, and use of relay devices for relaying traffic between other devices in a WLAN. In some embodiments, the controller/processor 240 includes at least one microprocessor or microcontroller.

The controller/processor 240 is also capable of executing other processes and programs resident in the memory 260, such as operations for facilitating setup, management, and use of relay devices for relaying traffic between other devices in a WLAN. The controller/processor 240 can move data into or out of the memory 260 as required by an executing process. In some embodiments, the controller/processor 240 is configured to execute a plurality of applications 262, such as applications for facilitating setup, management, and use of relay devices for relaying traffic between other devices in a WLAN. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antennas 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

In the embodiments of this disclosure, a relay device can be any type of WI-FI capable device. For instance, a relay can be a Mobile AP MLD, a non-AP MLD (e.g., peer-to-peer (P2P), or a normal end device), another AP MLD, a dedicated relay device, etc. The embodiments are applicable for both MLO as well as non-MLO operation. Additionally, the endpoint user device that uses relay functionalities to connect to its associated AP can be referred to as a destination STA. The AP that the destination STA intends to connect to via the relay can be referred to as a root AP. For simplicity, the destination STA may be referred to hereinafter as the STA, and the root AP may be referred to hereinafter as the AP.

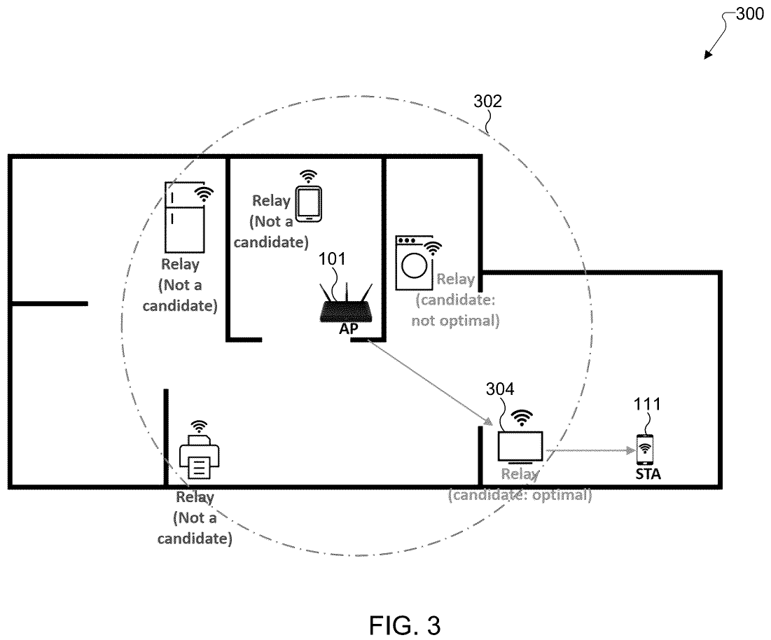

FIG. 3 illustrates an example scenario 300 for use of a WI-FI relay according to embodiments of the present disclosure. The example scenario 300 may be a smart home in which there are a number of devices such as TVs, tablets, and the like that have WI-FI support. These devices may be configured to act as relays to enhance the range of the access point. In this example, the AP may be an AP 101, and the STA may be a STA 111. It is understood that this process could be applied with any suitable WI-FI devices, such as MLDs having any number of affiliated APs or STAs. For ease of explanation, it is understood that references to an AP and a STA in further embodiments below refer to the AP 101 and STA 111, respectively.

In the example of FIG. 3, the AP's range is shown by the dotted circle 302. When a user steps outside this circle, the user's device (e.g., STA 111) gets poor connection or connection is unavailable. A relay (such as relay device 304) can act as an intermediate node and forward the user's traffic to the AP (and vice versa) so that even when the user's device is in weak connection areas it can continue to receive WI-FI connectivity.

In another example scenario, the user may be inside the AP's range but there may be a transmit power asymmetry. For instance, due to power constraints, the user's device can be transmitting at lower power compared to the AP (which can be wall powered and hence can transmit at higher power). Consequently, the user can be able to hear the AP's transmission on the downlink, however, on the uplink, the AP may not be able to hear the user's transmission. A relay can be useful in such scenarios as well.

Various embodiments of the present disclosure provided herein below describe procedures for relay operation setup.

According to one embodiment, the STA can send a relay setup request message when it determines that it needs a relay operation to continue the connectivity with the AP. The need for a relay operation can be determined based on a number of parameters—e.g., weakening of signal strength to the current AP, operation at the edge of the basic service set (BSS), a drop in throughput, etc. The relay setup request message can contain one or more of the information items described in Table 1.

TABLE 1

| Information | |
|---|---|
| item | Description |
| Relay operation | An information item that can indicate that the STA needs a relay based |
| requirement | support. E.g., this can be a field that can take a predetermined value to |
| indication | make the indication. In another example, this can also be a reason code. |
| Relay operation | An information item that can indicate the timing information associated |
| timing | with relay operation. E.g., the start time of relay operation |
| information | |
| Relay operation | An information item that can indicate the duration for which the relay |
| duration | operation can last. E.g., a duration indicated in terms of the TUs, TBTT, |
| | etc. |
| Relay identifier | An information item that can indicate the identification of the desired |
| | relay(s). E.g., relay MAC address(s). If a desired relay is not known, then |
| | such an indication can also be provided. |
| Performance | An information item that can describe the required performance from the |
| requirement | relay. E.g., downlink/uplink latency, throughput, data rate, quality of |
| | service (QoS) requirements, etc. |
| AP identifier | An information item that can indicate the identifier of the AP. Such an |
| | information item can be useful if the request message is sent to the relay |
| | instead of the AP. E.g., AP BSSID, MAC address, etc. |
| Required | An information item(s) that can indicate the operation features that the |
| features from | STA desires from the relay. E.g., requirement for rTWT, TWT, EPCS, |
| the relay | power save mode support, etc. |
| Link | An information item(s) that can indicate the link(s) on which the relay |
| information | operation is desired. E.g., this can be a link ID bitmap. |
| Request | An information item that can serve as a reference for the relay setup |
| message | request message. E.g., a dialog token. |
| identifier | |
| Traffic | An information item that can indicate the direction of the traffic for which |
| direction | the relay operation is needed. E.g., if direction of traffic is downlink |
| information | and/or uplink. |
| Transmit power | An information item that can indicate the transmit power and transmit |
| information | power configuration of the STA (for MLO operation this can be per link). |
| | This can enable the AP and/or the relay to estimate the communication |
| | speeds between themselves and the other entities involved in relay |
| | operation. |
| Channel | An information item that can indicate the channel statistics information |
| statistics | such as channel utilization, CCA, idle time, etc. This information can be |
| | useful for a number of reasons. For instance, this can enable the relay to |
| | decide how much delays can be faced when communicating with a STA |
| | as these delays can also impact its own traffic. In another example, this |
| | can be useful to compute the end to end communication speed or the |
| | communication speed between different entities involved in relay |
| | operation. |
| Relay buffer | An information item that can describe the buffer requirements that the |
| requirements | STA can need from the relay. This can enable the AP to search for the |
| | right relay for the STA. |
| QoS | An information item that can describe the QoS requirements that the relay |
| requirements | should be able to achieve. The STA can state these requirements based on |
| | the characteristics of the traffic that can get served via relay operation. |
| AP to STA link | An information item that can describe the signal strength on the link |
| strength | between the AP and the STA. For instance, the STA can provide the AP |
| information | with information related to SNR, RSSI, etc. that the STA has for |
| | downlink transmissions from the AP. This can enable the AP to |
| | understand if the downlink transmissions to the STA and relay is only |
| | needed for uplink transmissions or relay operation needs to be used for |
| | both downlink and uplink transmission. |

The above indicated message can be transmitted via one or more frames/elements/fields/subfields. These frames/elements/fields/subfields can be newly defined, or can be any of those existing in the standard. Some examples are as follows.

The following embodiments relate to the use of an element by a STA for transmitting a relay setup request message.

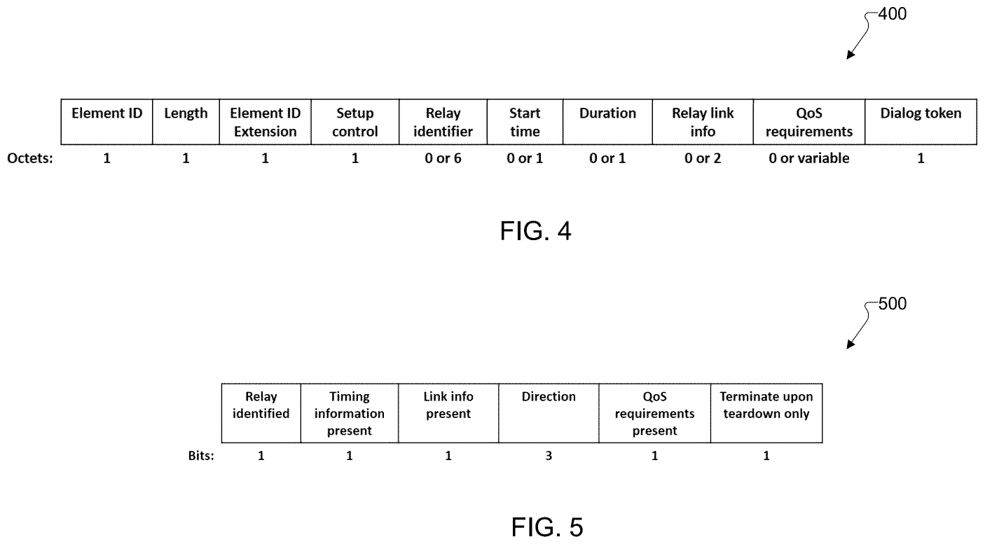

FIG. 4 illustrates an example element format 400 according to embodiments of the present disclosure. This format may be used for a relay setup request message transmitted in an element.

FIG. 5 illustrates an example setup control field format 500 of an element according to embodiments of the present disclosure. This format may be used for the setup control field of the element of FIG. 4.

In the example of FIG. 5, the relay identified bit can be set to 1 if the appropriate relay has been identified already (e.g., using the discovery process described previously). When set to 1, the relay identifier can be included in the element in FIG. 4. Otherwise, this field can be excluded from the element. If an appropriate relay has not been identified, then the bit can be set to 0.

The timing information present bit can be set to 1 if the STA has timing information available which can be included in the start time field and the duration field. If the STA does not know the timing information, this bit can be set to 0.

The link info present bit can be set to 1 if the relay link info field is present in the element of FIG. 4.

The direction bit can indicate the direction of traffic for which the relay operation may be required. Example encoding for this field can be as shown in Table 2.

TABLE 2

| Bit value | Meaning |
|---|---|
| 000 | All directions are possible. |
| 001 | Downlink only |
| 010 | Uplink only |
| 011 | Peer to peer |
| 100 | AP to AP |
| 101-111 | Reserved |

The QoS requirements present bit can be set to 1 if the QoS requirements field is present in FIG. 4. Otherwise, it can be set to 0.

The terminate upon teardown only bit can be set to 1 if the relay operation can be terminated only upon teardown. For instance, if the STA knows the start time but needs the relay for a very long duration, or does not intend to specify a duration and wants the relay operation to terminate only upon a teardown, then this bit can be set to 1. If there is no such requirement, then this bit can be set to 0.

Referring now to the example element format 400 of FIG. 4, the relay identifier field, if present, can be an identifier (e.g., MAC address) for the relay that the STA wants to use for relay operations. If the STA has not identified a relay for relay operation, then this field can be omitted. If the STA omits this field, then the AP can make a recommendation for the relay to use for relay operation.

The start time field can indicate the start time of the relay operation. The duration field can indicate the duration for which the relay operation can be desired. If the terminate upon teardown only bit in the setup control field of FIG. 5 is set to 1 then this field can be omitted.

The relay link info field can be a link ID bitmap which can indicate the link or links on which the relay operation is needed. A value of 1 in the bit position i of this bitmap can indicate to the receiver that the transmitter needs relay operations on the link with link ID equal to i. A value of 0 in the bit position i of this bitmap can indicate to the receiver that the transmitter does not need relay operations on the link with link ID equal to i.

The QoS requirements field can carry the QoS requirements specified by the transmitter for the relay operation. For instance, the STA can include a QoS characteristic element in this field when sending the element.

The dialog token can be a non-zero value that can be chosen by the requesting entity of the frame to identify the request/response transaction.

The following embodiments relate to the use of a control frame by a STA for transmitting a relay setup request message.

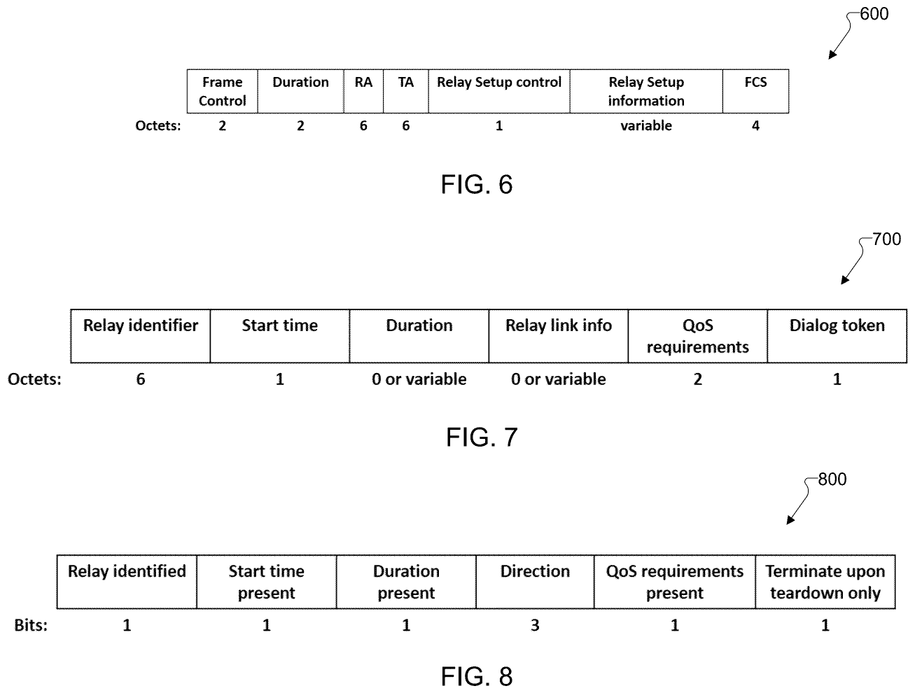

FIG. 6 illustrates an example control frame format 600 according to embodiments of the present disclosure. This format may be used for a relay setup request message transmitted in a control frame.

FIG. 7 illustrates an example relay setup control field format 700 of a control frame according to embodiments of the present disclosure. This format may be used for the relay setup control field of the control frame of FIG. 6. In the example of FIG. 7, the subfields may have the same meaning as the matching fields in FIGS. 4 and 5.

FIG. 8 illustrates an example relay setup information field format 800 of a control frame according to embodiments of the present disclosure. This format may be used for the relay setup information field of the control frame of FIG. 6. In the example of FIG. 8, the fields may have the same meaning as the matching fields in FIGS. 4 and 5.

The following embodiments relate to the use of an action frame by a STA for transmitting a relay setup request message. The action frame can have a format as shown in Table 3.

TABLE 3

| Order | Information |
|---|---|
| 1 | Category |
| 2 | Protected Action |
| 3 | Dialog Token |
| 4 | Setup request element |

In Table 3, the category field indicates the category of the action frame. The protected action field can enable to differentiate the protected action frame formats. The dialog token can be a non-zero value that can be chosen by the requesting entity of the frame to identify the request/response transaction. The setup request element can have a format as described in the example of FIG. 4.

Upon receiving the relay setup request message from the STA (according to any of the above embodiments), the AP can process the message and provide a response message (e.g., a relay setup response message) to the STA. The response can indicate if the AP can communicate with the STA via the relay. Prior to sending the response message, the AP can also check with the relay to ensure that the relay is willing to participate in the communication. If the AP already knows that the relay is willing to participate (e.g., based on advertisement by the relay, based on prior communication with the relay, etc.) then the AP can use that information to generate the response message instead. In some embodiments, the response can be transmitted in an unsolicited manner, without prior receipt of a request.

The response message from the AP can contain one or more of the information items indicated in Table 4.

TABLE 4

| Information | |
|---|---|
| items | Description |
| Status | An information item indicating the status of the request. E.g., status code. |
| information | |
| Timing | An information item indicating the timing information for relay operation. |
| information | E.g., the start time. |
| Duration | An information item indicating the duration for which the relay based |
| information | operation can be used. |
| Request | An information item that can indicate the request to which this response |
| identifier | corresponds to. E.g., dialog token that was used for the request message. |
| Relay | An information item that can identify the relay(s) that can be used for relay |
| identifier | operation. E.g., relay MAC address. |
| AP identifier | An information item that can identify the AP whose traffic the relay can |
| | handle. E.g., AP MAC address, BSSID, etc. |
| STA identifier | An information item that can identify the STA(s) whose traffic the relay |
| | can handle. E.g., STA MAC address. |
| Reason | An information item that can describe the reason for the particular |
| information | response such as a reason code. E.g., if the AP rejects the STA's request |
| | for a relay support because it cannot find a relay that can meet the STA's |
| | performance requirement then it can make that indication. |
| Traffic | An information item that can indicate the direction of the traffic for which |
| direction | the relay operation can be performed. E.g., if direction of traffic is |
| information | downlink or uplink. |
| Relay | An information item that can describe that the device is capable of acting |
| capability | as a relay. E.g., this can be a field (e.g., a bit) that can take a predetermined |
| identifier | value (e.g., 1) to make the indication. When the device can no longer serve |
| | as a relay, this field can take a different value (e.g., 0). |
| Root AP | An information item that can describe the link(s) on which the relay can |
| communication | receive frames from/transmit frames to the root AP |
| link | |
| information | |
| STA | An information item that can describe the link(s) on which the relay can |
| communication | receive frame from/transmit frames to the end device. This can be the same |
| link | set of links as those used for communication with the AP and can be |
| information | indicated together with the above information item. |
| Relay | An information item that can describe the capability of the relay node. |
| capability | E.g., supported data rates for transmission to and from the end device and |
| | for transmission to and from the AP, queuing delays at the relay, transmit |
| | power level constraints, features supported (e.g., rTWT), etc. |
| Relay type | An information item that can indicate the type of the relay. E.g., if this is |
| | an amplify and forward relay or a decode and forward relay. |
| Relay device | An information item that can describe the maximum number of nodes that |
| limit | the relay can support if such a limit exists for the relay. E.g., relay can |
| | consider its own power save and QoS constraints and determine how many |
| | STAs it can serve. |
| Relay per | An information item that can describe the maximum amount of traffic load |
| device load | that the relay can support per device. |
| limit | |
| Service pause | An information item that can describe if the device has temporarily paused |
| | its relay services. |
| AP signal | An information item that can describe the received signal strength of the |
| strength | AP at the relay. This can enable the STA to choose the relay that has the |
| | strongest signal strength from the AP. E.g., RSSI, SNR, SINR, etc. |
| Relay signal | An information item that can describe the received signal strength of the |
| strength | relay at the AP. This can enable the STA to choose the relay that has the |
| | strongest signal strength at the AP. E.g., RSSI, SNR, SINR, etc. |
| AP and relay | An information item that can indicate an estimate of the communication |
| communication | rate for the path between the relay and the AP (e.g., net rate, downlink rate, |
| speed | uplink rate, etc.). For instance, this can be an estimate of the |
| information | communication rate for AP to relay path that the STA can get if it |
| | communicates via the relay. The relay can take into account the actual |
| | communication rate and if it is currently using the link for other traffic |
| | (e.g., relay's own traffic, traffic of relay's BSS if relay is a Mobile AP/AP, |
| | traffic of other STAs which the relay is serving, etc.) it can estimate how |
| | much communication rate can be experienced by a new STA when it starts |
| | to communicate via the relay. The relay can update this rate each time a |
| | STA joins the relay. For MLO operation, this can be either a per link |
| | estimate and/or an aggregate estimate. AP can obtain this information from |
| | the relay. AP can also compute this information based on any |
| | information/statistics that it obtains from the relay. |
| Relay and | An information item that can indicate the relay to STA communication rate |
| STA | for the path between the relay and the STA (e.g., net rate, downlink rate, |
| communication | uplink rate, etc.). For instance, this can be an estimate of the |
| speed | communication rate for relay to STA path that the STA can get if it |
| information | communicates via the relay. The relay can take into account the actual |
| | communication rate and if it is currently using the link for other traffic |
| | (e.g., relay's own traffic, traffic of relay's BSS if relay is a Mobile AP/AP, |
| | traffic of other STAs which the relay is serving, etc.) it can estimate how |
| | much communication rate can be experienced by a new STA when it starts |
| | to communicate via the relay. The relay can update this rate each time a |
| | STA joins the relay. For MLO operation, this can be either a per link |
| | estimate and/or an aggregate estimate. AP can obtain this information from |
| | the relay. AP can also compute this information based on any |
| | information/statistics that it obtains from the relay. |
| End to end | An information item that can indicate the end to end communication rate |
| communication | that STA can get if it communicates via the relay. For instance, the relay |
| speed | can provide this information based on a reference STA (the reference |
| information | STA's signal strength to the relay, bandwidth, etc. can be either a pre- |
| | known value based on the spec or can be separately advertised by the relay |
| | as an additional information item). For MLO operation, this can be either a |
| | per link estimate and/or an aggregate estimate. AP can obtain this |
| | information from the relay. AP can also compute this information based on |
| | any information/statistics that it obtains from the relay. |
| Channel | An information item that can describe the channel statistics such as CCA, |
| statistics | channel utilization, idle time, etc. This can also be per link and can be |
| | advertised either on the same link and/or in a cross link manner. This |
| | information can be for the path between the relay and the AP and/or the |
| | path between the relay and the STA. AP can obtain this information from |
| | the relay. AP can also compute this information based on any |
| | information/statistics that it obtains from the relay. |
| Resource | An information item that can describe any kind of resource constraints |
| constraints | such as the buffer capacity that the relay has or can use for relay operation. |
| | E.g., if the relay has hardware limitations and can dedicate only a certain |
| | portion of its buffer capacity for buffering relayed traffic, then it can make |
| | this advertisement. This information can comprise any description of |
| | buffer configuration, buffer sizes, buffer characteristics, buffer |
| | management policies for certain traffic types, etc. This can be useful for |
| | the STA to choose a relay based on its buffer capacity and one that is |
| | suited to its own traffic characteristics. E.g., if the STA has a bulk |
| | download that will have bursty traffic with large burst lengths, then this |
| | information can help it choose a relay that can provide a bigger buffer for |
| | relay operations. On the other hand, if the STA's traffic is not going to |
| | require big buffer sizes, then it can choose a relay that can provide a |
| | smaller buffer size. AP can obtain this information from the relay. AP can |
| | also compute this information based on any information/statistics that it |
| | obtains from the relay. |
| Transmit | An information item that can describe the transmit power information for |
| power | the relay. E.g., this can be the transmit power per link/transmit power |
| information | configuration per link. AP can obtain this information from the relay. AP |
| | can also compute this information based on any information/statistics that |
| | it obtains from the relay. |

The above indicated message can be transmitted via one or more frames/elements/fields/subfields. These frames/elements/fields/subfields can be newly defined, or can be any of those existing in the standard. Some examples are as follows.

The following embodiments relate to the use of an element by an AP for transmitting a relay setup response message.

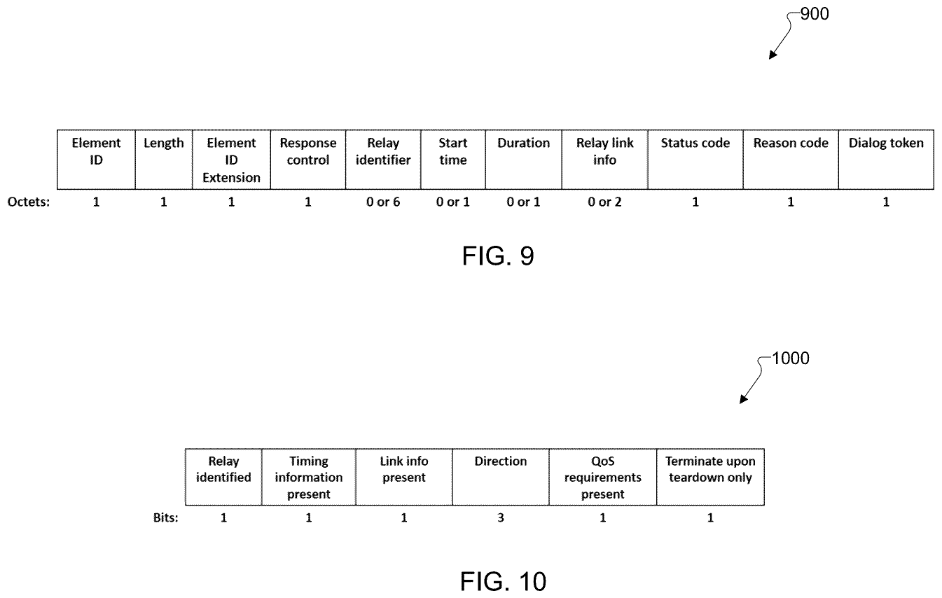

FIG. 9 illustrates an example element format 900 according to embodiments of the present disclosure. This format may be used for a relay setup response message transmitted in an element.

FIG. 10 illustrates an example response control field format 1000 of an element according to embodiments of the present disclosure. This format may be used for the response control field of the element of FIG. 9.

In the example of FIGS. 9 and 10, the transmitter of the response element can suggest a relay for relay operation, for instance if the response is an unsolicited response. In such a case, the relay identified bit in FIG. 10 can be set to 1 and the relay identifier (e.g., MAC address, relay ID, etc.) can be included in the relay identifier field in FIG. 9. In another example, if the ideal relay for the STA is different from the one indicated in the request, then the relay identified bit in FIG. 10 can be set to 1 and the relay identifier can be inserted in the relay identifier field in FIG. 9.

In the example of FIG. 10, the timing information present bit can be set to 1 if the timing information is present in the response element of FIG. 9. For instance, if the response is an unsolicited response, then the start time and the duration field can be indicated. In another example, if the relay operation timing information is different from that stated in the request message, then the response message can indicate the final values.

The link info present bit can be set to 1 to indicate that the relay link info field is present in the response element of FIG. 9. This can be used if the transmitter has to suggest a different link set from the one suggested in the request, or if this is an unsolicited response.

The direction subfield can indicate the direction of the traffic as suggested by the transmitter of the response message, and the encoding can be as shown in Table 2.

The QoS requirements present bit can be set to 1 if the QoS requirements field is present in the response element of FIG. 9. Otherwise, it can be set to 0.

The terminate upon teardown only bit can be set to 1 if the relay operation can be terminated only upon teardown. For instance, if the AP transmits an unsolicited response to the STA, then it can indicate whether the relay operation can terminate after the duration value in the duration field expires from the start time indicated in the start time field, or whether the operation can continue until it is terminated using a termination procedure by either entity.

Referring now to the example element format 900 of FIG. 9, the start time can indicate the start time of relay operation. E.g., if the start time suggested in the request is not feasible, then the transmitter of the response can transmit a different start time value.

The duration field can indicate the duration of relay operation from the start time. E.g., if the duration suggested in the request is not feasible, then the transmitter of the response can transmit a different duration value.

The relay link info field can be a link ID bitmap which can indicate the link or links on which the relay operation is needed. A value of 1 in the bit position i of this bitmap can indicate to the receiver that the transmitter needs relay operations on the link with link ID equal to i. A value of 0 in the bit position i of this bitmap can indicate to the receiver that the transmitter does not need relay operations on the link with link ID equal to i.

The status code field can indicate the status of the request as identified by the request message, e.g., if the status is a failure or a success. If the status is a failure, then the request can be made at a later point in time. In the case of a failure, the fields described above can be omitted.

The reason code field can indicate the reason for the transmission of the response message. If the status code indicates a failure, then the reason code can indicate the reason for the failure, e.g., failed due to an overload condition at the relay, failed due to unavailability of a relay, unavailability of a relay that can satisfy the QoS requirements, etc.

The dialog token can be the same value as the one indicated in the request message. This can indicate which request message the response message corresponds to.

The following embodiments relate to the use of a control frame by an AP for transmitting a relay setup response message.

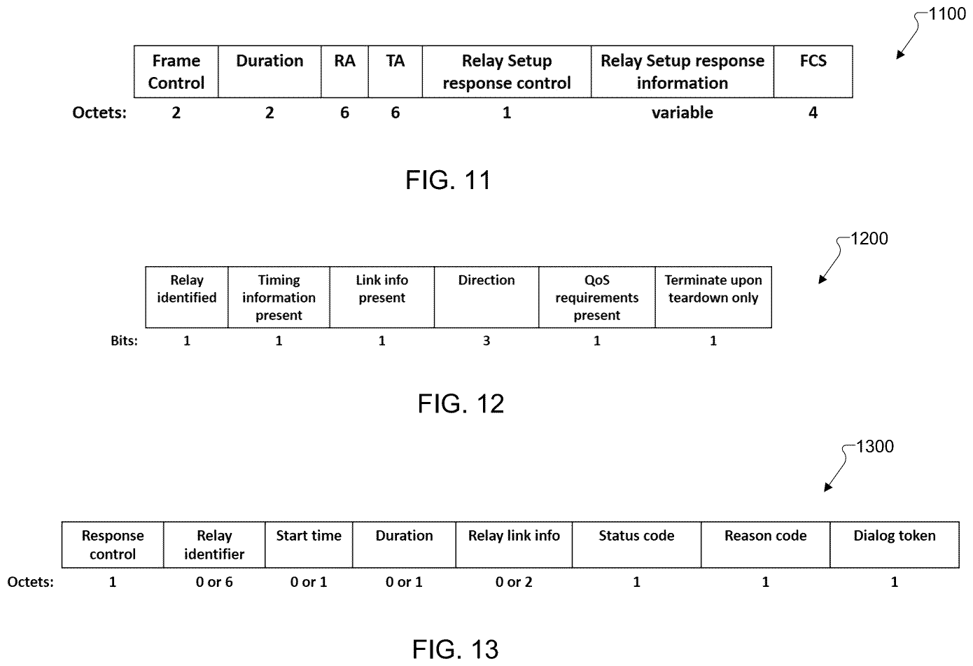

FIG. 11 illustrates an example control frame format 1100 according to embodiments of the present disclosure. This format may be used for a relay setup response message transmitted in a control frame.

FIG. 12 illustrates an example relay setup response control field format 1200 of a control frame according to embodiments of the present disclosure. This format may be used for the relay setup response control field of the control frame of FIG. 11. In the example of FIG. 12, the fields may have the same meaning as the matching fields in FIGS. 9 and 10.

FIG. 13 illustrates an example relay setup response information field format 1300 of a control frame according to embodiments of the present disclosure. This format may be used for the relay setup response information field of the control frame of FIG. 11. In the example of FIG. 13, the fields may have the same meaning as the matching fields in FIGS. 9 and 10.

The following embodiments relate to the use of an action frame by an AP for transmitting a relay setup response message. The action frame can have a format as shown in Table 7.

TABLE 7

| Order | Information |
|---|---|
| 1 | Category |
| 2 | Protected Action |
| 3 | Dialog Token |
| 4 | Reason code |
| 5 | Status code |
| 6 | Setup response element |

In Table 7, the category field indicates the category of the action frame. The protected action field can enable to differentiate the protected action frame formats. The dialog token can be the same value as indicated in the corresponding request message. The setup response element can have a format as described in the example of FIG. 9.

According to another embodiment, the AP can send a relay setup request message containing one or more of the information items as indicated in Table 1 to the STA. For instance, if the AP determines that the downlink transmissions to a STA are failing due to poor signal strength and the AP wants to use relay transmissions, then the AP can send the relay setup request message to the STA. Upon receiving the request message from the AP, the STA can send a response message containing one or more of the information items as indicated in Table 4.

According to another embodiment, the AP can also send an unsolicited response message to the STA and vice versa. For instance, if the AP does not want to negotiate a relay setup with the STA and has determined on its own that the STA can be served via an existing relay to meet its QoS requirements, then the AP can send an unsolicited response message to the STA and start relay operation.

According to one embodiment, the STA can transmit a relay setup request message to the relay. The relay setup request message can contain one or more of the information items as indicated in Table 1. The relay can process the message and can transmit a relay setup response message to the STA. When processing the message, the relay can consider factors such as whether the STA's QoS requirements can be met, if performing relay operation for the STA would hinder its own operation, etc. The relay setup response message can contain one or more of the information items as indicated in Table 4.

Additionally, the relay, the STA, or both can also transmit a relay setup response message to the AP to inform the AP that the relay can serve the STA for relay operation. This can enable the AP to route the STA's traffic to the relay. For instance, the relay can already be advertised by the AP and the AP can be using the relay for some of its other STAs. In such a situation, the AP can directly start to route the STA's traffic to the relay. Upon receiving the STA's traffic, the relay can then forward it to the STA.

Any of the signaling described with respect to FIGS. 4-13 can be used for this communication and setup initiated by the STA.

According to one embodiment, the AP can transmit a relay setup request message to the relay. The relay setup request message can contain one or more of the information items as indicated in Table 1. The relay can process the message and can transmit a relay setup response message to the AP. When processing the message, the relay can consider factors such as whether the STA's QoS requirements can be met, if performing relay operation for the STA would hinder its own operation, etc. The relay setup response message can contain one or more of the information items as indicated in Table 4.

Additionally, the relay, the AP, or both can also transmit a relay setup response message to the STA to inform the STA that the relay can serve the STA for relay operation. This can enable the STA to be aware that the AP can direct its traffic via the relay.

Any of the signaling described with respect to FIGS. 4-13 can be used for this communication and setup initiated by the AP.

When the AP makes a relay setup request to the relay, the AP can do so for one or more than one STA associated with the AP in the same relay setup request message. In such a case, the request message can carry a list of STA identifiers and a list of the corresponding QoS requirements for each of those STAs. Additionally, the AP can also assign an identifier (e.g., such as an AID) to a relay during the setup.

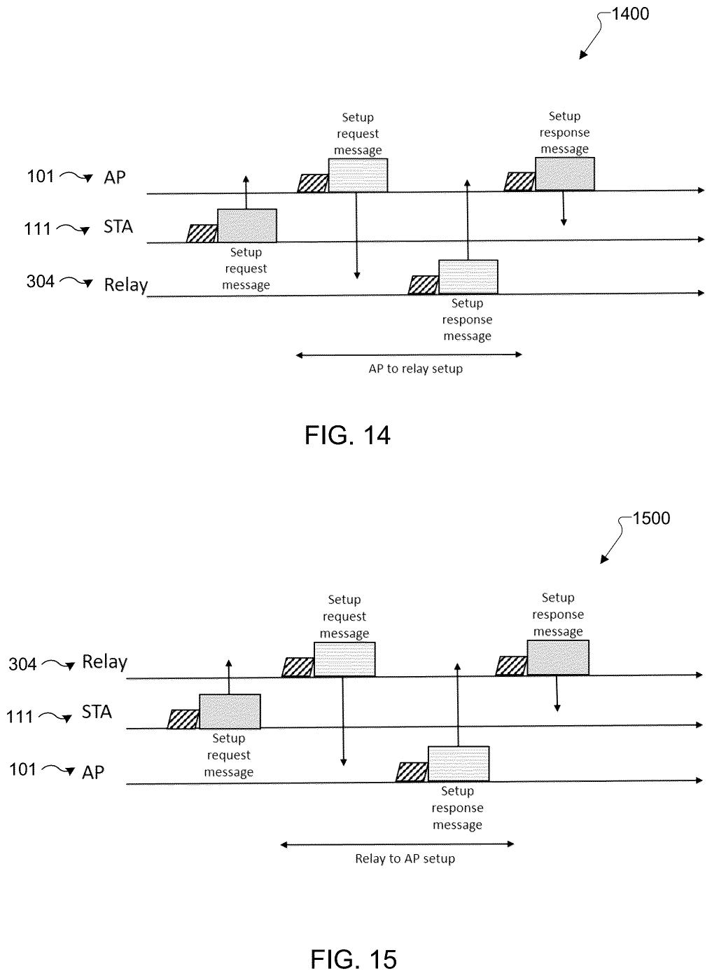

FIG. 14 illustrates an example relay setup procedure 1400 initiated by the STA with the AP according to embodiments of the present disclosure. In this example, the STA determines a need for relay operations for its communications with the AP, and the STA requests the AP to setup relay operations.

As illustrated in FIG. 14, the STA can transmit a relay setup request message to the AP. The STA may have identified the relay in advance or it can indicate to the AP that it needs a relay recommendation. If the AP has already discovered a relay, then it can begin AP-to-relay setup by transmitting a setup request message to the relay as shown. Upon receiving the message, the relay can process the message and can transmit the relay setup response message. Upon receiving this confirmation from the relay, the AP can transmit a relay setup response message to the STA and the relay operation can start at the indicated start time.

In some embodiments, if the AP has not discovered the relay at the time when it receives a setup request message from the STA, then the AP can start a relay discovery procedure prior to the setup procedure shown in FIG. 14. Upon completing the discovery procedure, the AP can start the setup procedure with the relay.

In one example, a mobile STA may have already crossed into an area where it is out of the coverage of the AP. However, the STA may be aware of the relays that it can use (e.g., based on the AP's advertisement). In such a case, the STA can start a setup procedure with the relay directly.

FIG. 15 illustrates an example relay setup procedure 1500 initiated by the STA with the relay according to embodiments of the present disclosure. In this example, the STA requests the relay to setup relay operations. The relay can then perform relay-to-AP setup with the AP. Following the setup, the relay can send a relay setup response message to the STA. The relay operation can then start at the indicated start time.

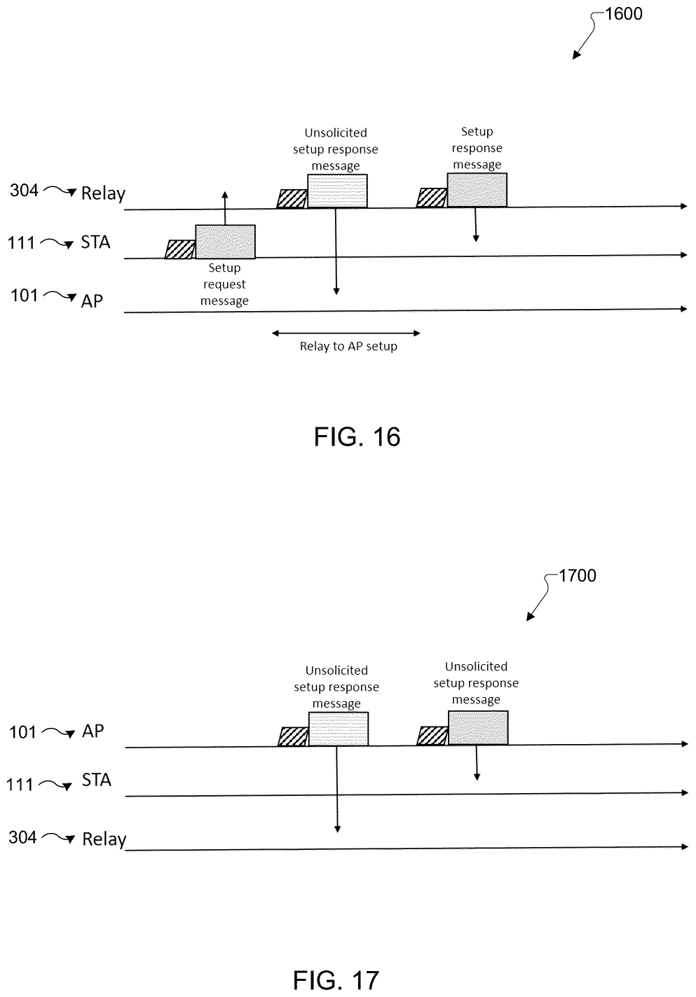

FIG. 16 illustrates another example relay setup procedure 1600 initiated by the STA with the relay according to embodiments of the present disclosure. The example of FIG. 16 is a variation of the example of FIG. 16. In this example, the relay is already performing relay operations for the AP and determines that it can handle the additional STA. In this case, the relay can transmit an unsolicited setup response message to the AP instead of performing the entire setup with the AP.

FIG. 17 illustrates an example relay setup procedure 1700 initiated by the AP with the relay according to embodiments of the present disclosure. In this example, the AP can determine that its associated STA needs relay assistance for communication. The AP may know of a relay that is already providing assistance to some of the other STAs associated with the AP. The AP can transmit an unsolicited setup response message to the relay if it is certain that the relay can handle the additional STA. Following this, the AP can transmit an unsolicited setup response message to the STA to inform the STA that its traffic will be relayed through the relay following the start time indicated in the response message. At the indicated start time, the AP can relay the STA's traffic through the relay.

Various embodiments of the present disclosure provided herein below describe procedures for terminating (e.g., tearing down) the relay operation.

According to one embodiment, the STA can initiate a teardown of the relay operation. For instance, the STA may no longer need the relay operation as it may have moved into the range of the AP and the signal strength to the AP can be sufficient to meet its QoS requirements. In another example, the STA may want to switch to another AP in a different BSS which the relay may not be serving, and thus may want to terminate the relay operation.

The STA can transmit a teardown message to initiate the teardown procedure. The teardown message can contain one or more of the information items as indicated in Table 8.

TABLE 8

| Information | |
|---|---|
| item | Description |
| STA | An information item that can describe the STA for which the relay |
| identifier | operation needs to be torn down. E.g., STA MAC address |
| AP identifier | An information item that can describe the AP who the STA is associated |
| | with. E.g., AP MAC address, BSSID, etc. |
| Relay | An information item that can describe the relay that needs to stop |
| identifier | performing the relay operation. E.g., relay MAC address. |
| Timing | An information item that can describe the time at which the teardown needs |
| information | to happen. |
| Link | An information item that can describe the link(s) on which the teardown |
| information | needs to happen. If this is for all the link(s) then such an indication can also |
| | be given. |
| Traffic | An information item that can describe the traffic streams for which the |
| information | teardown needs to happen. E.g., specific TID(s) indicated via a TID bitmap. |
| Message | An information item that can serve as a reference for the message. E.g., |
| identifier | dialog token. |
| Disassociation | An information item that can provide an indication and information |
| information | necessary for disassociation. For instance, if the STA is planning to |
| | disassociate with the AP after relay operation is terminated, it can make this |
| | indication. |
| Reason | An information item that can provide a reason for sending the teardown |
| information | message. E.g., a reason code. |

The above indicated message can be transmitted via one or more frames/elements/fields/subfields. These frames/elements/fields/subfields can be newly defined, or can be any of those existing in the standard. Some examples are as follows.

The following embodiments relate to the use of an element by a STA for transmitting a relay teardown message.

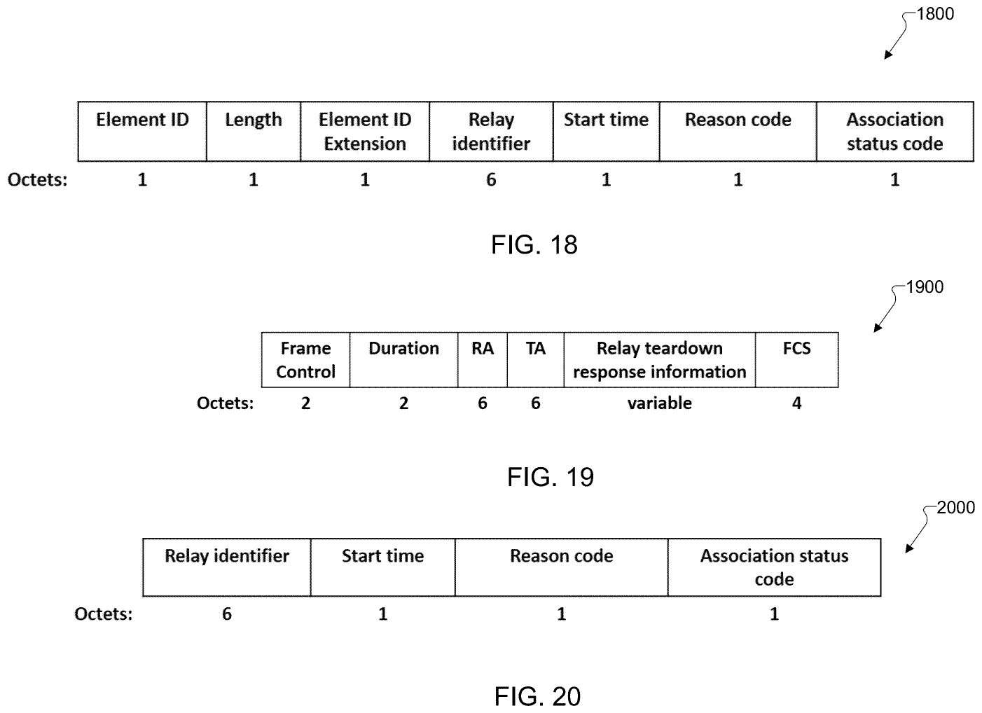

FIG. 18 illustrates an example element format 1800 according to embodiments of the present disclosure. This format may be used for a relay teardown message transmitted in an element.

In the example of FIG. 18, the relay identifier can identify the relay with which the communication needs to be torn down. The start time can indicate the time at which the communication needs to be torn down. The reason code can indicate the reason for transmitting this frame.

The association status code can be a status code that can indicate the state of the association following the teardown. E.g., whether following the teardown the STA can still continue to be associated with the AP or the STA wants to move to a different AP. If the STA plans to stay connected to the current AP, then the AP can directly communicate with the STA. If the STA plans to move to a different AP, then the AP can disassociate the STA.

The following embodiments relate to the use of a control frame by a STA for transmitting a relay teardown message.

FIG. 19 illustrates an example control frame format 1900 according to embodiments of the present disclosure. This format may be used for a relay teardown message transmitted in a control frame.

FIG. 20 illustrates an example relay teardown response information field format 2000 of a control frame according to embodiments of the present disclosure. This format may be used for the relay teardown response information field of the control frame of FIG. 19. In the example of FIG. 20, the subfields may have the same meaning as the matching fields in FIG. 18.

The following embodiments relate to the use of an action frame by a STA for transmitting a relay teardown message. The action frame can have a format as shown in Table 9.

TABLE 9

| Order | Information |
|---|---|
| 1 | Category |
| 2 | Protected Action |
| 3 | Reason code |
| 4 | Teardown element |

In Table 9, the category field indicates the category of the action frame. The protected action field can enable to differentiate the protected action frame formats. The reason code can indicate the reason for the teardown. The teardown element can have a format as described in the example of FIG. 18.

The STA can transmit the above teardown message to the relay or the AP. If the STA transmits the teardown message to the relay, then the relay can forward it to the AP. If the STA transmits a teardown message to the AP, then the AP can inform the relay.

Upon teardown, the AP can either directly start transmitting frames to the STA or, if the STA has made a disassociation indication, the AP can take actions necessary to facilitate disassociation/handover.

According to one embodiment, the AP can initiate a teardown of the relay operation. The AP can transmit a relay teardown message to the relay, the STA, or both to terminate the relay operation. The teardown frame can contain one or more of the information items as indicated in Table 8. The AP can send a teardown message to the relay to inform the relay that the AP will no longer relay its traffic through the relay. If, upon teardown, the STA can remain associated with the AP, then the AP can transmit frames to the STA directly. Otherwise, the AP can disassociate the connection with the STA.

According to one embodiment, the relay initiate a teardown of the relay operation by transmitting a teardown message. For instance, the relay may no longer want to function as a relay and may want to tear down the relay connection. In order to do so, the relay can transmit a teardown message to the AP, the STA, or both to terminate the relay operation. The teardown frame can contain at least or more of the information items as indicated in Table 8. Upon receiving the teardown message from the relay, the AP can stop routing the STA's traffic to the relay. Similarly, the STA can stop routing its uplink traffic to the AP through the relay.

In one example, the STA transmits a teardown message to the relay. The relay can forward the message to the AP. Upon receipt of the message, the AP can stop forwarding the STA's downlink frames to the relay. The relay can discard any queued frames of the STA that are pending transmission. The STA can stop transmitting its uplink frames to the relay.

In another example, the AP can transmit a teardown message to the relay. The relay can forward the message to the STA. Upon receiving the message, the STA can stop forwarding the uplink frames to the relay. The relay can discard any pending traffic of the STA, and the AP can stop forwarding the downlink traffic to the relay.

Various embodiments of the present disclosure provided herein below describe procedures for capability advertisement related to relay operation.

According to one embodiment, an AP that can support relay operation—i.e., support routing traffic to an associated STA through a relay—can advertise the capability in one or more frames that it transmits. The capability advertisement message can contain one or more of the information items as indicated in Table 10.

TABLE 10

| Information | |
|---|---|
| item | Description |
| Capability | An information item that can indicate that the AP can support relay |
| support | operation for its associated STAs. |
| indicator | |
| Relay | An information item that can indicate if the AP can advertise information |
| advertisement | about relays in the network. |
| presence | |
| indicator | |
| Relay limit | An information item that can indicate the maximum number of relays that |
| count | the AP can support at a time. |
| Relayed STA | An information item that can indicate the maximum number of STAs |
| count | whose traffic can be relayed at a given point in time. |

The above indicated message can be transmitted via one or more frames/elements/fields/subfields. These frames/elements/fields/subfields can be newly defined, or can be any of those existing in the standard. For instance, the above information items can be present in management frames such as beacons.

STAs that receive such an indication can be aware of the AP's capability to provide support for relay operations and can request relay operations when necessary. STAs can also use this information to determine the best AP to associate with. E.g., STAs may prefer an AP that has relay support over an AP that does not.

Relays that receive such an indication can be aware that the AP may need their support in the future.

According to one embodiment, a relay can advertise its support for relay operation. The relay can advertise this support in one or more frames that it transmits. The capability advertisement message can contain one or more of the information items as indicated in Table 11.

TABLE 11

| Information | |
|---|---|
| item | Description |
| Capability | An information item that can indicate that the relay can support relay |
| support | operation. |
| indicator | |
| AP indicator | An information item that can indicate the APs for which the relay |
| | operation can be supported. STAs associated with those APs can reach |
| | out to the relay for assistance. E.g., this can be a list of AP identifiers such |
| | as MAC addresses, BSSIDs, etc. |
| Max STA count | An information item that can indicate the maximum number of STAs that |
| | the relay can support at a time. |
| Current active | An information item that can indicate the AP(s) that the relay is already |
| AP(s) | providing relay support to. This can indicate to the STA that using this |
| | relay can be faster as part of the setup with the AP is already established. |

The above indicated message can be transmitted via one or more frames/elements/fields/subfields. These frames/elements/fields/subfields can be newly defined, or can be any of those existing in the standard. For instance, the above information items can be present in management frames such as beacons (if the relay is an AP/Mobile AP), probe request frames (if the relay is a non-AP STA), etc.

APs that receive such an indication from a non-AP STA can be aware of the presence of relays in their range. This can enable such an AP to setup and advertise relay availability for its associated STAs.

According to one embodiment, a STA can advertise its support for relay operation. The STA can advertise this support in one or more frames that it transmits. The capability advertisement message can contain one or more of the information items as indicated in Table 12.

TABLE 12

| Information item | Description |
|---|---|
| Capability support | An information item that can indicate that the |
| indicator | STA can support relay operation. |

The above indicated message can be transmitted via one or more frames/elements/fields/subfields. These frames/elements/fields/subfields can be newly defined, or can be any of those existing in the standard. For instance, the STA can provide the above indication in management frames such as probe requests, (Re)association requests, etc.

It is understood that the procedures and signaling described in this disclosure are applicable to multi-link operation as well and should not be considered as being limited to single link operation.

One or more of the fields in any of the examples provided in this disclosure can be absent. Additional fields can be present in the examples provided in this disclosure.

Various embodiments of the present disclosure provided herein below describe procedures for relay assisted communication setup between a STA and AP.

According to one embodiment, a relay can assist a STA to discover APs in the vicinity. The relay can also assist a STA to discover and receive any updates to an associated AP or other APs in the vicinity. E.g., if the associated AP or AP in the vicinity performs any type of reconfiguration such as channel change, band change, turning on/off any feature/capability, etc.

According to this embodiment, the STA can transmit a discovery request message to the relay. The transmitted discovery request message can contain one or more of the information items as depicted in Table 13.

TABLE 13

| Information | |
|---|---|
| item | Description |
| Discovery | An information item that can provide an indication that the STA needs an |
| request | assistance from the relay to perform discovery. E.g., this can be done in an |
| indication | explicit manner if the discovery request message is a part of any of the |
| | existing frame. This can also be done in an implicit manner if the discovery |
| | request message is a newly defined frame. If the frame is a newly defined |
| | frame, then receipt of the frame can be considered as an implicit request. |
| Performance | An information item that can indicate the necessary performance that the |
| requirements | STA expects once connected to the AP. For instance, QoS requirements, |
| | DL rates, UL rates, signal strength to AP, delay tolerance, etc. This can |
| | enable the relay to determine the suitable AP for the STA. |
| Response | An information item that can indicate how the STA wants to hear the |
| format | response. E.g., Relay can compile all the responses from the AP and |
| | transmit to the STA or relay individual responses to the STA. |
| Acknowledgement | An information item that can indicate if the STA needs an |
| indication | acknowledgement from the relay regarding the receipt of the discovery |
| | request message. |
| Response | An information item that can indicate any timeout values for the relay to |
| timeout | send a response to the STA after discovering all the APs. |
| Configuration | An information item that can describe the configuration of the STA or |
| info | alternatively any possible restrictions on the STA configuration. E.g., if the |
| | STA only supports/prefers a select set of operating channels, bands, etc. |
| Scanning | An information item that can indicate the type of scanning that the STA |
| requirements | wants the relay to perform. E.g., if the STA wants the relay to perform |
| | active scanning or passive scanning. |
| Timing | An information item that can indicate the amount of time that the relay can |
| requirements | take to perform the discovery operations. E.g., this can be the maximum |
| | amount of time that the relay can take. |
| AP identifier | An information item that can indicate one or more AP identifiers. E.g., |
| | MAC address, BSSID, etc. For instance, if the STA has any preference on |
| | the APs that it wants to associate with, it can make the indication. |
| Communication | An information item that can describe the communication speed between |
| speed | the AP and the STA that the STA expects upon association with the AP. |
| between AP | This can help to filter out the AP(s) that cannot meet the STAs |
| and STA | requirements. |
| Traffic | An information item that can describe the traffic characteristic of the STA. |
| characteristics | This can enable the relay to find the best AP for the STA based on its traffic |
| | characteristics. E.g., if the STA is running a high throughput application, an |
| | AP that can provide the highest throughput can be desirable. On the other |
| | hand, if the STA is running a low latency application that does not have a |
| | high throughput requirement, then an AP that can provide low latency |
| | support can be desired. |

The above information items can be transmitted together or separately. They can be transmitted as a part of any existing frame/element/field/subfield in the standard or can be a part of newly defined frames/elements/fields/subfields.

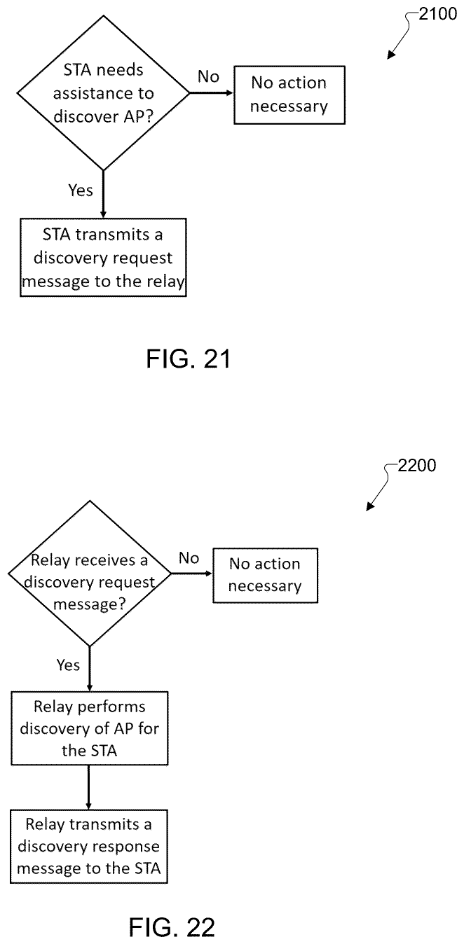

FIG. 21 illustrates an example discovery request procedure 2100 according to embodiments of the present disclosure. The example discovery request procedure 2100 may be performed by a STA according to the above embodiment.

Upon receiving the discovery request message, the relay can perform discovery of APs in the vicinity (e.g., using any of the procedures listed in this disclosure) and provide a discovery response message to the STA. The discovery response message can contain one or more of the information items as indicated in Table 14.

TABLE 14

| Information | |
|---|---|
| items | Description |
| AP discovery | An information item that can indicate that the relay has discovered AP(s) |
| indication | in the vicinity. E.g., this can be a bit that can be set to 1 if the relay has |
| | discovered AP(s) in the vicinity and to 0 if the relay has not discovered |
| | any AP(s) in the vicinity. |
| AP identifiers | An information item that can describe the identity of the discovered AP(s). |
| | E.g., BSSID, MAC address, etc. The AP identifiers can also be |
| | ordered/ranked from the best to the worst based on the STA's criteria. This |
| | can help the STA in assessing the AP that it can get associated with for a |
| | satisfactory performance. |
| AP | An information item that can describe the configuration of the discovered |
| configuration | AP(s). E.g., their operating bands/channels, link configuration, power |
| | saving constraints, etc. |
| AP capabilities | An information item that can describe the capabilities of the discovered |
| | AP(s). E.g., a list of features that the AP supports such as EPCS, rTWT, |
| | etc. The information item can also describe the constraints of the |
| | discovered AP such as power save constraints, NSTR constraints, etc. |
| Supported | An information item that can describe the performance that can be |
| performance | supported with the AP(s). E.g., DL rates, UL rates, estimated delays, |
| | estimated QoS performance, etc. |
| Probe response | An information item that can contain a list of probe responses from the AP |
| list | or any of the information items therein. This can enable the STA to |
| | process the information on its own and assess the best AP to associate |
| | with. |
| Beacon info | An information item that can contain information obtained by the relay |
| list | from the beacons of the APs that can be useful to the STA for making an |
| | association decision. |
| Relay | An information item that can describe the AP that can provide better |
| preferred AP | performance to the STA based on the assessment of the relay. E.g., AP |
| | MAC address, BSSID, etc. |
| Signal strength | An information item that can describe the signal strength from the AP at |
| to AP | the relay. E.g., RSSI, SNR, etc. |
| AP to relay | An information item that can describe the AP to relay communication |
| communication | speed. The relay can compute this speed based on one or more parameters |
| speed | shared by the AP or measured by it. This speed can be the downlink |
| | communication speed and/or the uplink communication speed. Further, |
| | this speed can be one a per link basis or as an aggregate statistic. |
| Relay | An information item that can describe if the relay can assist the STA or |
| assistance | not. Relay may not assist every STA that makes a discovery request. Relay |
| response | can provide assistance to only select STAs that have a membership for |
| | relay operation. Other STAs can be denied membership. The relay can |
| | either transmit a discovery response message that can indicate that the |
| | relay cannot assist the STA. In another embodiment, the relay can simply |
| | not send any message to the STA and the STA can consider a timeout after |
| | a certain period of time and seek assistance from a different relay or |
| | perform no further action until another relay or AP is discovered by the |
| | STA. |

The above information items can be transmitted together or separately. They can be transmitted as a part of any existing frame/element/field/subfield in the standard or can be a part of newly defined frames/elements/fields/subfields.

FIG. 22 illustrates an example discovery response procedure 2200 according to embodiments of the present disclosure. The example discovery response procedure 2200 may be performed by a relay according to the above embodiment.

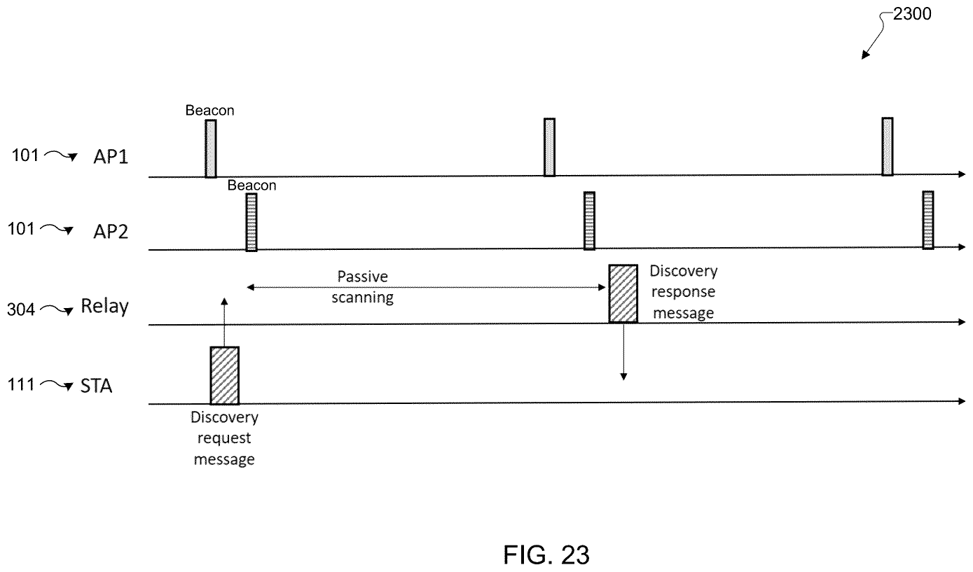

FIG. 23 illustrates an example relay assisted AP discovery procedure 2300 according to embodiments of the present disclosure. In this example, the STA cannot discover AP1 or AP2 on its own. Consequently, it seeks the relay's assistance to do the discovery.

As illustrated in FIG. 23, the STA can transmit a discovery request message to the relay. Upon receiving the discovery request message, the relay can perform passive scanning and check the APs whose beacons it can hear. Upon completion of the passive scanning procedure, AP1 and AP2 are the discovered APs. The relay can then transmit a discovery response message providing information regarding discovered APs to the STA.

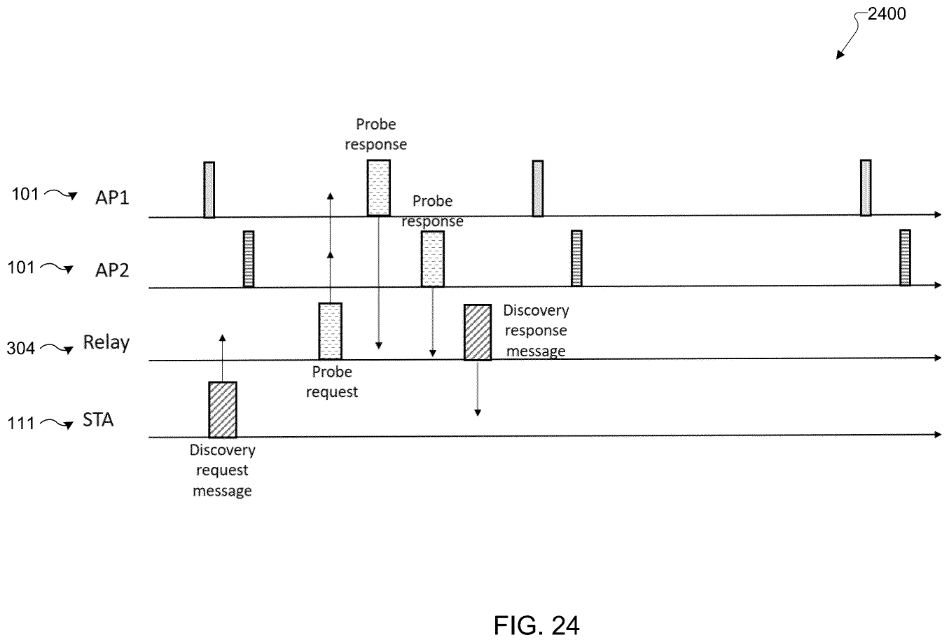

FIG. 24 illustrates another example relay assisted AP discovery procedure 2400 according to embodiments of the present disclosure. This example is similar to the example of FIG. 23, except the relay performs active scanning instead of passive scanning—e.g., the relay transmits a probe request, and receives probe responses from AP1 and AP2 in response. Upon completion of the active scanning procedure, AP1 and AP2 are the discovered APs.

In yet another example, the relay can perform a mix of passive and active scanning for APs.

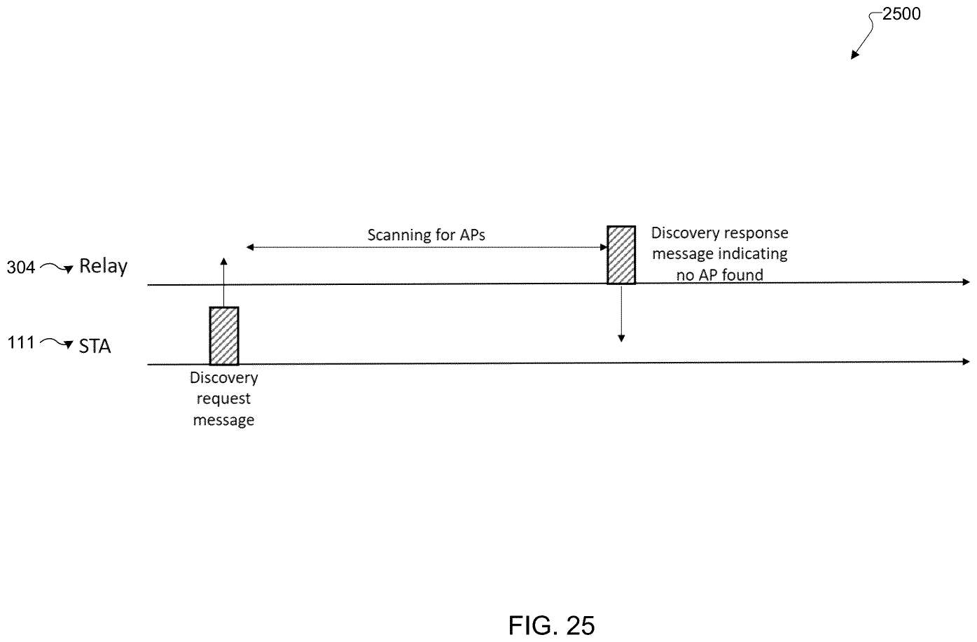

FIG. 25 illustrates another example relay assisted AP discovery procedure 2500 when no APs are found according to embodiments of the present disclosure. In this example, the relay is unable to discover any APs in the vicinity. The relay can then send a discovery response message indicating that it cannot find any APs in the vicinity. This may apply to both active and passive scanning.

The STA may also provide to the relay one or more statistics to enable the relay to compute which APs are suitable for the STA. The statistics can provide the relay with information that is necessary to compute the end to end communication speed. The statistic conveying message can contain one or more of the information items as shown in Table 15.

TABLE 15

| Information | |
|---|---|
| item | Description |
| Channel statistic | An information item that can describe the channel statistic at the STA |
| | side. E.g., the CCA, channel utilization, idle time, etc. This information |
| | can be provided on a per link basis in case of multi-link operation. |
| Signal strength | An information item that can describe the signal strength of the relay at |
| from the relay | the STA side. E.g., SNR, SINR, RSSI, etc. This information can be |
| | provided on a per link basis in case of multi-link operation. |
| Transmit power | An information item that can describe the transmit power or the transmit |
| information | power configuration of the STA side. This information can be provided |
| | on a per link basis in case of multi-link operation. |
| Signal strength | An information item that can describe the signal strength from nearby |
| from the AP | APs to the STA. E.g., SNR, SINR, RSSI, etc. This information can be |
| | provided on a per link basis in case of multi-link operation. |
| Delays on the | An information item that can describe the delays that can be faced by the |
| STA side | frames of various traffic types (e.g., AC, TIDs, etc.) on the STA side. |
| | This can enable the relay to compute the end to end delays for the STA. |

The above information items can be transmitted together or separately. They can be transmitted as a part of any existing frame/element/field/subfield in the standard or can be a part of newly defined frames/elements/fields/subfields. This message can be provided independently or along with the discovery message.

The relay can use the information from the statistic conveying message to compute the end to end communication speed that can be achieved for downlink and uplink traffic of the STA. The relay can use this computation to provide recommendation or ranking of the APs in the vicinity based on expected performance that the STA can achieve after association.

In order to facilitate this computation, the relay can request statistics from the AP by transmitting a statistic request message to the AP either independently or along with any of the messages that it transmits to the AP. The statistic request message can contain one or more of the information items as indicated in Table 16.

TABLE 16

| Information | |
|---|---|
| item | Description |
| Requested | An information item that can provide a description of the statistic that the |
| statistic | relay can request. For instance, this can be a bitmap with each bit location |
| | representative of a requested statistic such as those listed in Table 3. |
| Measurement | An information item that can indicate the duration over which the |
| duration | measurements can be performed by the AP. |
| Response | An information item that can indicate if the AP needs to provide the |
| procedure | statistic to the relay independently or in one of the messages that it |
| | transmits as a part of the discovery procedure. |

The above information items can be transmitted together or separately. They can be transmitted as a part of any existing frame/element/field/subfield in the standard or can be a part of newly defined frames/elements/fields/subfields.

Upon receiving the statistic request message, the AP can process the message and provide a statistic response message. The response message can contain one or more of the information items as indicated in Table 17.

TABLE 17

| Information | |
|---|---|
| item | Description |
| Channel statistic | An information item that can describe the channel statistic at the AP |
| | side. E.g., the CCA, channel utilization, idle time, etc. This information |
| | can be provided on a per link basis in case of multi-link operation. |
| Signal strength | An information item that can describe the signal strength of the relay at |
| from the relay | the AP side. E.g., SNR, SINR, RSSI, etc. This information can be |
| | provided on a per link basis in case of multi-link operation. |
| Transmit power | An information item that can describe the transmit power or the transmit |
| information | power configuration of the AP side. This information can be provided on |
| | a per link basis in case of multi-link operation. |
| Delays on the | An information item that can describe the delays that can be faced by the |
| AP side | frames of various traffic types (e.g., AC, TIDs, etc.) on the AP side. This |
| | can enable the relay to compute the end to end delays for the STA. |

The above information items can be transmitted together or separately. They can be transmitted as a part of any existing frame/element/field/subfield in the standard or can be a part of newly defined frames/elements/fields/subfields.

The relay can also provide the information obtained from the statistic conveying message (referring to Table 15) from the STA to the AP. Along with the statistics provided by the STA, the relay can also share some statistics from its own end. This message that the relay transmits to the AP can contain both the information from the relay side and the information provided by the STA to the relay side. The AP can process both sets of information and assess the end to end speed that the STA can obtain. This can enable the AP to make its own recommendation of a relay (if there is more than one relay that the STA can use for relaying its traffic to the AP) should the STA choose to associate with it. The information provided by the relay for itself can contain one or more of the information items as shown in Table 18.

TABLE 18

| Information | |
|---|---|
| item | Description |
| Channel | An information item that can describe the channel statistic at the relay side. |
| statistic | E.g., the CCA, channel utilization, idle time, etc. This information can be |
| | provided on a per link basis in case of multi-link operation. |
| Signal | An information item that can describe the signal strength of the relay at the |
| strength from | relay side. E.g., SNR, SINR, RSSI, etc. This information can be provided |
| the relay | on a per link basis in case of multi-link operation. |
| Transmit | An information item that can describe the transmit power or the transmit |
| power | power configuration of the relay side. This information can be provided on |
| information | a per link basis in case of multi-link operation. |
| Delays on the | An information item that can describe the delays that can be faced by the |
| STA side | frames of various traffic types (e.g., AC, TIDs, etc.) on the STA side. This |
| | can enable the relay to compute the end to end delays for the STA. |

In another embodiment, the relay can collect statistics such as those listed in Table 15 and Table 18 about itself and the AP and provide them to the STA. The STA can then compute the end to end communication speed and assess the best AP to associate with.

According to one embodiment, the relay can assist the STA in performing scanning operations.

According to one such embodiment, a relay can assist a STA to perform passive scanning. According to this embodiment, the STA can transmit a scanning request message to the relay. The scanning request message can contain one or more of the information items as indicated in Table 12. This message can indicate to the relay the amount of time that the relay can take to perform the scanning. The relay can perform passive scanning and respond back to the STA with the collected information in a response containing one or more of the information items as indicated in Table 13.

According to one embodiment, a relay can perform active scanning to assist the STA using the procedures described above with respect to the relay-assisted AP discovery.

According to one embodiment, a relay can assist a STA to associate with an AP. To request association, a STA can transmit an association assistance request message to the relay. The association assistance request message can contain one or more of the information items as indicated in Table 19.

TABLE 19

| Information | |
|---|---|
| item | Description |
| AP identifier | An information item indicating the AP that the relay can assist the STA to |
| | associate with. E.g., AP MAC address, BSSID, etc. |
| Relay | An information item that can indicate the relay through which the STA can |
| identifier | communicate to the AP after association. E.g., Relay MAC address, etc. |
| Association | One or more of the information items that are present in the association |
| request | request frame that the STA can send when not using relay operation. |
| content | |
| Configuration | An information item(s) that can describe the setup that the STA can use |
| after | after association. E.g., link configuration with the relay, etc. |
| association | |
| Context | An information item that can provide the context for sending this frame. |
| information | E.g., a reason code/field that can indicate that the STA is sending the frame |
| | to request assistance from the relay in association. |

The above information items can be transmitted together or separately. They can be transmitted as a part of any existing frame/element/field/subfield in the standard or can be a part of newly defined frames/elements/fields/subfields.

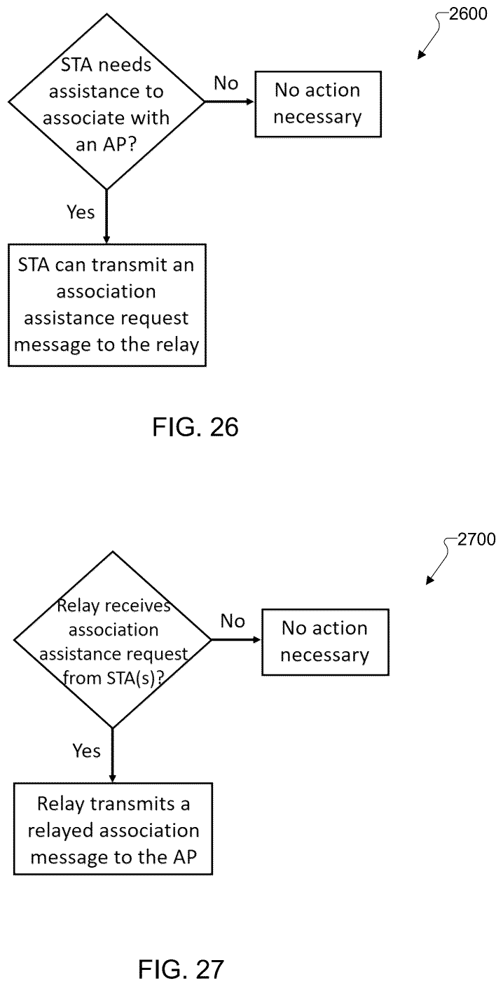

FIG. 26 illustrates an example association assistance request procedure 2600 according to embodiments of the present disclosure. The example association assistance request procedure 2600 may be performed by a STA according to the above embodiment.

Upon receiving the above message from the STA, the relay can perform association with the AP. The relay can transmit a relayed association request message to the AP that can contain one or more of the information items as indicated in Table 20.

TABLE 20

| Information | |
|---|---|
| item | Description |
| AP identifier | An information item indicating the AP that the relay can assist the STA(s) |
| | to associate with. E.g., AP MAC address, BSSID, etc. |
| Relay | An information item that can indicate the relay through which the STA(s) |
| identifier | can communicate to the AP after association. E.g., Relay MAC address, etc. |
| Association | One or more of the information items that are present in the association |
| request | request frame that the STA(s) can send when not using relay operation. |
| content | |
| Configuration | An information item(s) that can describe the setup that the STA(s) can use |
| after | after association. E.g., link configuration with the relay, etc. |
| association | |
| Context | An information item that can provide the context for sending this frame. |
| information | E.g., a reason code/field that can indicate that the relay is sending the frame |
| | to assist with the association procedure of a STA(s). |

The above information items can be transmitted together or separately. They can be transmitted as a part of any existing frame/element/field/subfield in the standard or can be a part of newly defined frames/elements/fields/subfields.

The purpose of the relayed association message can be to indicate to the AP that the STA intends to communicate with the AP via the relay after the setup and is using the relay's help in association. The relay can compile multiple requests from different STAs if they happen to send requests around the same time. The relay can send the compiled information to the AP for one or more STAs in the relayed association message.

FIG. 27 illustrates an example association assistance request message handling procedure 2700 according to embodiments of the present disclosure. The example association assistance request message handling procedure 2700 may be performed by a relay according to the above embodiment.

Upon completion of association, the relay can forward an association response status message to the STA. The association response status message can contain one or more of the information items as indicated in Table 21.

TABLE 21

| Information | |
|---|---|
| item | Description |
| AP identifier | An information item that can indicate the AP for which the relay has |
| | completed the association procedure for the STA. E.g., AP MAC address, |
| | BSSID, etc. |
| Relay | An information item that can indicate the relay through which the STA can |
| identifier | communicate with the AP. |
| Association | One or more of the information items that are present in the association |
| response | response frame that the STA can receive when not using relay operation. |
| content | |
| Configuration | An information item(s) that can describe the setup that the STA can use |
| after | after association. E.g., link configuration with the relay, etc. |
| association | |
| Context | An information item that can provide the context for sending this frame. |
| information | E.g., a reason code/field that can indicate that the STA is sending the frame |
| | to request assistance from the relay in association. |

The above information items can be transmitted together or separately. They can be transmitted as a part of any existing frame/element/field/subfield in the standard or can be a part of newly defined frames/elements/fields/subfields.

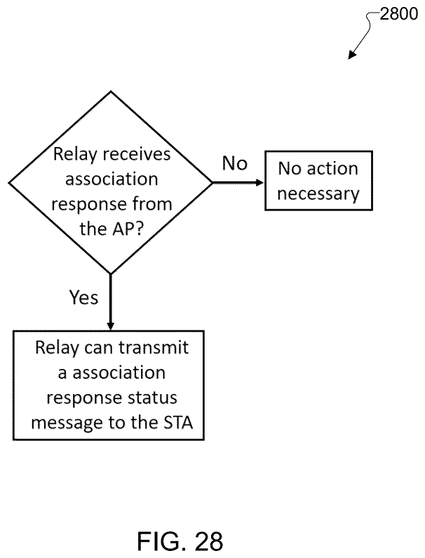

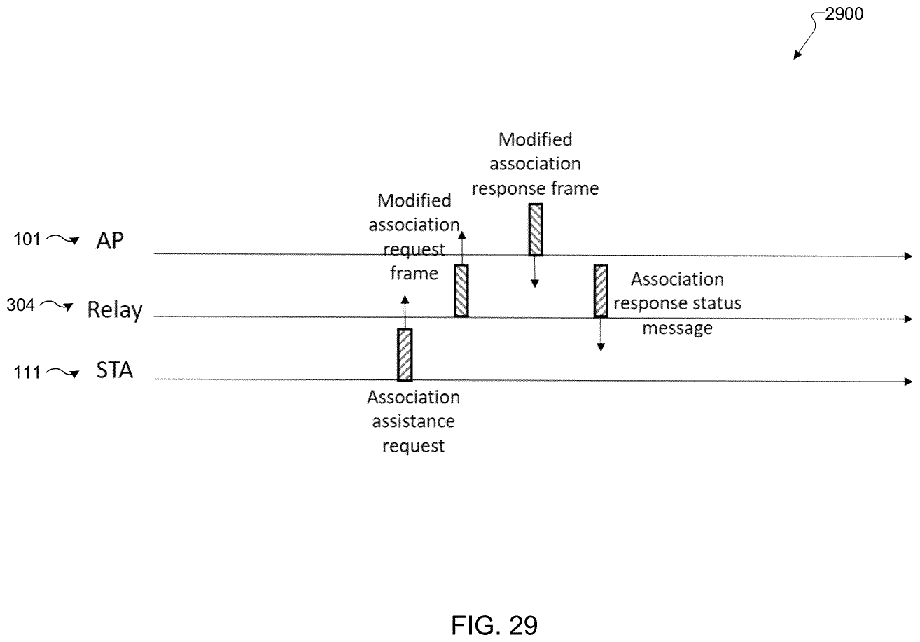

FIG. 28 illustrates an example association response status message procedure 2800 according to embodiments of the present disclosure. The example association response status message procedure 2800 may be performed by a relay according to the above embodiment.

FIG. 29 illustrates an example relay assisted AP association procedure 2900 according to embodiments of the present disclosure. In this example, a STA makes a request to the relay for assistance with association with an AP.

As illustrated in FIG. 29, the STA transmits an association assistance request message to the relay. The relay can then transmit a relayed (or modified) association request message to the AP. Upon receiving the relayed association request message, the AP can process the message and transmit a relayed (or modified) association response to the relay. The relay can transmit an association response status message to the STA. The relayed association request message can be an association request frame containing an element that indicates that the relay is sending this message on behalf of the STA. The relayed association response message can be an association response frame containing an element that indicates that the AP is sending this message to the relay so that the relay can forward it to the STA.

A STA can seek assistance from a relay for association with an AP in many situations. Some example situations follow.

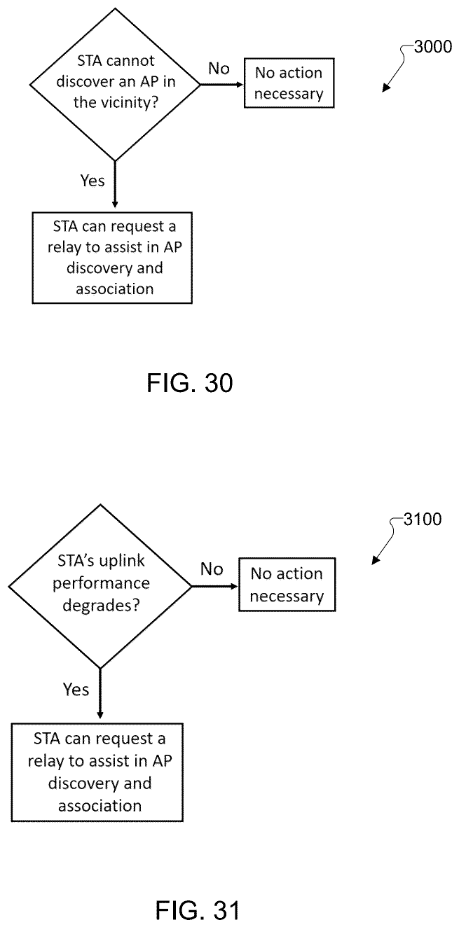

FIG. 30 illustrates an example relay assisted AP discovery and association procedure 3000 according to embodiments of the present disclosure. In this example, a STA can attempt to discover the AP on its own, and upon not being able to discover any APs in the vicinity the STA can make a request to the relay for assistance with AP discovery and association. The relay can then assist the STA in discovering an AP and associating with it.

FIG. 31 illustrates another example relay assisted AP discovery and association procedure 3100 according to embodiments of the present disclosure. In this example, the STA identifies that its uplink to the AP has degraded (e.g., due to poor signal strength, higher packet retransmission rate, etc.), and the STA then attempts to connect to the AP with the relay's assistance.

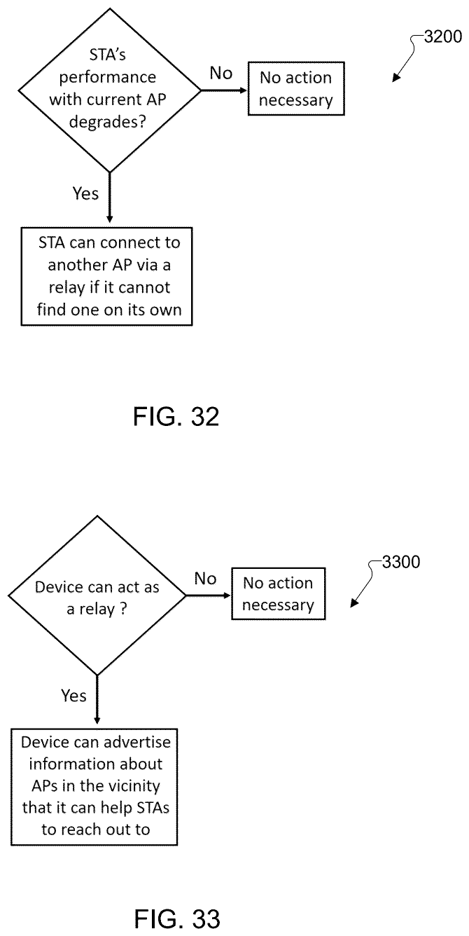

FIG. 32 illustrates another example relay assisted AP discovery and association procedure 3200 according to embodiments of the present disclosure. In this example, the STA is undergoing mobility and intends to switch to a new AP due to a poor link with the current AP, but cannot find any other APs in the vicinity. In this case the STA can leverage a relay's help to switch to a new AP.

According to one embodiment, a relay can provide information to STAs on the APs that it can reach out to. For instance, the relay may have discovered APs in its vicinity using passive scanning, active scanning, or both. If the relay is a Mobile AP, then such a procedure can be performed for backhaul creation. The relay can transmit the reachable AP information in an AP information message to STAs. The AP information message can contain one or more of the information items as indicated in Table 22.

TABLE 22

| Information | |
|---|---|
| item | Description |
| AP | An information item that can identify the APs that are reachable by the |
| identifier(s) | relay. This can be a list of AP identifiers. E.g., AP MAC address, BSSID, |
| | etc. |
| AP(s) | An information item that can describe the capabilities of the AP(s) listed in |
| capability | the AP identifier list. E.g., supported features, operational constraints such |
| information | as NSTR, multi-link configuration information, etc. |
| Associated | An information item that can indicate which AP(s) the relay can help a STA |
| AP(s) | to get associated with. |
| information | |

The above information items can be transmitted together or separately. They can be transmitted as a part of any existing frame/element/field/subfield in the standard or can be a part of newly defined frames/elements/fields/subfields.

FIG. 33 illustrates an example procedure 3300 for handling reachable AP information according to embodiments of the present disclosure. The example procedure 3300 may be performed by a relay according to the above embodiment to provide information to STAs on APs that the relay can assist with reaching out to.

The relay can obtain the above information by a number of methods. For instance, the relay can perform passive scanning based on the beacons it can hear from the APs in the vicinity, the relay can perform active probing, etc.

If the relay is an AP or Mobile AP, then the above message can be transmitted in management frames such as beacons, probe responses, etc.

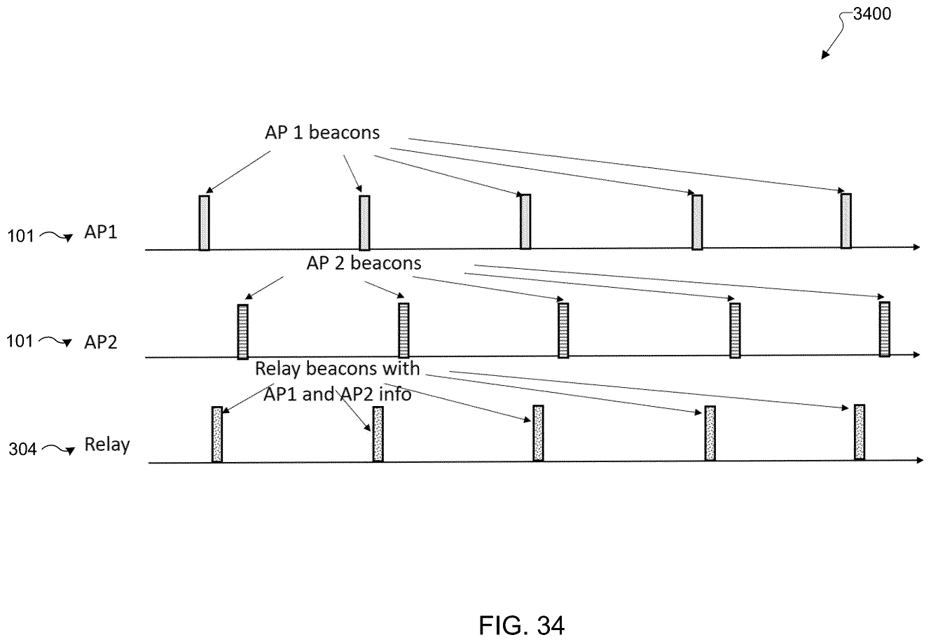

FIG. 34 illustrates an example operation 3400 for reachable AP advertisement according to embodiments of the present disclosure. In the example operation 3400, the relay is an AP or Mobile AP.

As illustrated in FIG. 34, the AP-based or Mobile AP-based relay can discover AP1 and AP2 based on hearing their beacons. The relay can then include information related to AP1 and AP2 in its own beacons. A STA that can hear the relay's advertisement beacons can understand which APs the relay can help the STA to connect to. If the STA wants to connect to one of the advertised APs, then the STA can make an association assistance request to the relay.

According to one embodiment, a relay can assist a STA to disassociate with the AP. The STA can transmit a request message for disassociation to the relay. The request message can contain one or more of the information items as shown in Table 23.

TABLE 23

| Information | |
|---|---|
| item | Description |
| AP identifier | An information item that can identify the AP that the relay can assist the |
| | STA to disassociate with. E.g., AP MAC address, BSSID, etc. |
| Disassociation | One or more of the information items that are present in the disassociation |
| message | frame that the STA can send when not using relay operation. |
| content | |

The above information items can be transmitted together or separately. They can be transmitted as a part of any existing frame/element/field/subfield in the standard or can be a part of newly defined frames/elements/fields/subfields.

The relay device can be any type of device in the above embodiments including, e.g., a P2P device. The relay, AP, and STA can also be multi-link devices.

Various embodiments of the present disclosure provided herein below describe procedures for timing information exchange for relay operation.

According to one embodiment, timing information can be shared between an AP, a relay, and a STA in relay-based communication. According to this embodiment, a timing information description message can be transmitted. The message can contain one or more of the information items as indicated in Table 24.

TABLE 24

| Information | |
|---|---|
| item | Description |
| Traffic | An information item that can serve as the traffic identifier. E.g., TID, AC, |
| identifier | etc. |
| Stream | An information item that can serve as the stream identifier. E.g., SCSID. |
| identifier | |
| Timing | An information item that can provide timing information for the indicated |
| information | frames. E.g., enqueue time, packet expiration time, time left before the |
| | packet expires, etc. This information can be indicated for one frame (e.g., |
| | head of the line frame) or for more than one frame(s). |
| Backlog | An information item that can provide the backlog information for the |
| information | indicated frames. |
| Device | An information item that can serve as an identifier for the device for whose |
| identifier | traffic the timing information corresponds to. E.g., if the relay has its own |
| | traffic that it transmits to the AP as well as the STA's traffic, then the relay |
| | can make an explicit indication that the information corresponds to the |
| | STA and not for itself. This an enable the AP to understand the QoS |
| | requirements for the traffic are the ones for the STA and not for the relay. |
| Intended | An information item that can serve as an identifier for the device which |
| device | will be the eventual receiver of the traffic. E.g., if the AP is sending the |
| identifier | timing information to the relay to pass on to the STA, then the AP can |
| | make an indication that the intended destination of the frames is the STA |
| | and not the relay. Alternatively, the AP can make a special indication (e.g., |
| | a bit set to 1 to make such an indication) if the timing information should |
| | be retained by the relay or forwarded to the STA. |
| Transmission | An information item that can indicate if the message corresponds to the |
| identifier | current transmission or to future transmissions. This can be a field (e.g., a |
| | bit) that can take a predetermined value (e.g., 1) if the information |
| | corresponds to the current transmission and another predetermined value |
| | (e.g., 0) if it corresponds to a future transmission. |
| Link identifier | An information item that can indicate the link on which the corresponding |
| | traffic can be transmitted. E.g., link ID, link ID bitmap, etc. |
| Delay | An information item that can indicate the delay tolerance for the current |
| tolerance | traffic. |

The above information items can be transmitted together or separately. They can be transmitted as a part of any existing frame/element/field/subfield in the standard or can be a part of newly defined frames/elements/fields/subfields.

If the AP receives such a timing information description message from the relay or the STA ahead of time, then the AP can take appropriate action (e.g., resource scheduling, triggered uplink, etc.) to ensure that the corresponding frames are received prior to their expiration time.

The AP can also transmit such a timing information description message to the relay, the STA, or both. For instance, the AP may want to wake up the relay, STA, or both for reception of frames prior to their expiration. The message from the AP can enable the relay and the STA to wake up and receive the traffic in time.

If the relay receives the timing information description message from the AP and the message corresponds to the current transmission, then the relay can use the information to assess if the current transmission is expired or will expire before it can transmit it to the STA. If so, then the relay can drop the frames and save air time consumption from transmission of the expired frames. If the frames are not transmitted in the first transmission and prior to one or more retransmissions the frames expire, then they can be dropped instead of being transmitted.

If the relay receives the timing information description message from the AP and it is meant for the STA, then the relay can transmit the message to the STA. E.g., the relay can include the message in its transmission to the STA.

If the relay receives the timing information description message from the AP or STA and it corresponds to a future transmission, then the relay can ensure that it stays awake to receive the future transmission. If the message is from the STA and the relay has the capability to trigger the STA for the transmission, then the relay can trigger the STA for transmission and receive the frames prior to their expiration.

If the relay has an urgent need to transmit frames to the AP or STA, then the relay can transmit the timing information description message as a part of its ongoing transmission to indicate the urgency. E.g., if the relay is transmitting frames for a different access class (AC), then the relay can include the message for other backlogged ACs as a part of this transmission. The receiver can take appropriate actions to handle the traffic prior to its expiration when possible. E.g., if the receiver is the AP, then the AP can trigger the relay in time before its frames expire or after reception ensure that the frames are not blocked due to a head-of-line (HOL) blocking issue.

If the STA receives the timing information description message from the AP or the relay, then the STA can stay awake to receive the corresponding frames if the message corresponds to a future transmission. If the message corresponds to the current transmission, then the STA can assess if the frames have expired and, if so, then it can drop the expired frames. This can prevent such expired frames from causing any additional delays (e.g., due to HOL blocking issues) to frames that are received afterwards.

If the STA has an urgent need to transmit frames, then the STA can transmit the timing information description message, e.g., as a part of a transmission or on its own.

According to one embodiment, there can be a negotiation procedure for a timing information description message. The negotiation procedure can involve the exchange of a request message that can contain one or more of the information items as indicated in Table 25.

TABLE 25

| Information | |
|---|---|
| item | Description |
| Traffic | An information item that can describe the traffic identifier of the frames |
| identifier | for which the timing information can be exchanged. E.g., TID, TID |
| | bitmap, etc. |
| Stream | An information item that can describe the stream identification for which |
| identifier | the timing information can be exchanged. E.g., SCS ID. |
| Duration | An information item that can indicate the duration for which the |
| | negotiation can be considered valid. After the duration is over, another |
| | negotiation can be needed to keep the negotiation active. |
| Start time | An information item that can indicate the start time from where the |
| | negotiation can take effect. E.g., the number of TBTTs from the current |
| | TBTT. |
| Requesting | An information item that can indicate the entity that is making the request. |
| entity | E.g., if the relay is forwarding the request from the STA, then the |
| identifier | requesting entity can be the relay. |
| Intended | An information item that can indicate the intended destination for the |
| destination | request frame. E.g., if the STA wants to negotiation with the AP, then the |
| | intended destination can be the AP. |

The above information items can be transmitted together or separately. They can be transmitted as a part of any existing frame/element/field/subfield in the standard or can be a part of newly defined frames/elements/fields/subfields.

Upon receiving the above negotiation request frame, a negotiation response frame can be generated by the responder. The negotiation response frame can contain one or more of the information items as indicated in Table 26.

TABLE 26

| Information | |
|---|---|
| item | Description |
| Traffic | An information item that can describe the traffic identifier of the frames |
| identifier | for which the timing information can be exchanged. E.g., TID, TID |
| | bitmap, etc. This can be a confirmation from the responder. |
| Stream | An information item that can describe the stream identification for which |
| identifier | the timing information can be exchanged. E.g., SCS ID. This can be a |
| | confirmation from the responder. |
| Duration | An information item that can indicate the duration for which the |
| | negotiation can be considered valid. After the duration is over, another |
| | negotiation can be needed to keep the negotiation active. This can be a |
| | confirmation from the responder. |
| Start time | An information item that can indicate the start time from where the |
| | negotiation can take effect. E.g., the number of TBTTs from the current |
| | TBTT. This can be a confirmation from the responder. |
| Status | An information item that can indicate the status of the request. E.g., a |
| information | status code that can indicate if the status is success or failure. |
| Reason | An information item that can indicate the reason for the response. E.g., a |
| information | reason code that can indicate the reason for denial if the request is a |
| | failure. |

The above information items can be transmitted together or separately. They can be transmitted as a part of any existing frame/element/field/subfield in the standard or can be a part of newly defined frames/elements/fields/subfields.

When the AP intends to initiate a timing information exchange procedure for a STA whose traffic is being handled by a relay, the AP can transmit a negotiation request frame to the relay, the STA, or both (e.g., if the STA can hear the AP's downlink transmissions).

When the AP receives a negotiation request frame from the STA or the relay, the AP can process the negotiation request frame and generate a response frame.

Upon completion of a negotiation for timing information exchange, the AP can then transmit/receive the timing information description message in frames that it transmits.

When the relay receives a negotiation request from the STA and the intended destination is the AP, the relay can forward the request to the AP with an indication that it is from the STA. If the intended destination is the relay, then the relay can generate a negotiation response frame and transmit it to the STA.

If the relay wants to generate a negotiation request on behalf of the STA (e.g., if the relay assesses that the STA's traffic is facing long delays), the relay can transmit a negotiation request frame to the AP, the STA, or both with an indication that the request is for the STA's traffic.

If the STA receives a negotiation request frame, the STA can process the frame and generate a negotiation response frame. If the STA wants to transmit timing information, then the STA can generate a negotiation request frame and transmit it to the appropriate entity.

An AP that can support a timing information exchange feature for relay operation can advertise that capability in one or more frames that it transmits (e.g., management frames such as beacons, probe responses, etc.). Likewise, a relay that can support a timing information exchange feature can advertise that capability in one or more frames that it transmits (e.g., if the relay is a Mobile AP, the relay can transmit the advertisement message in management frames such as beacons, probe responses, etc.). Similarly, a STA that can support a timing information exchange feature can advertise that capability in one or more frames that it transmits (e.g., probe request frame, association request frame, etc.).

The above procedures can apply to multi-link operation as well.

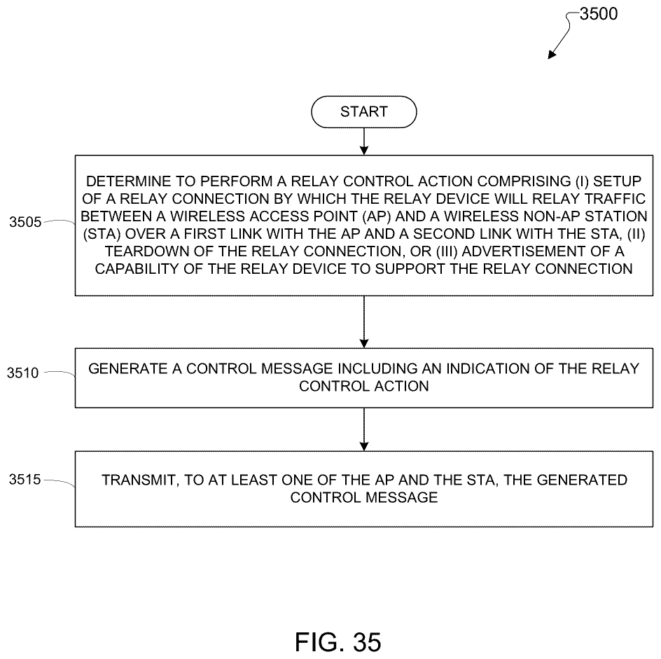

FIG. 35 illustrates an example process 3500 for setup, management, and use of relay devices for relaying traffic between other devices according to various embodiments of the present disclosure. The process 3500 of FIG. 35 is discussed as being performed by a relay device configured to form a first link with an AP and a second link with a STA, but it is understood that a corresponding AP and STA perform corresponding processes. It is understood that any suitable WI-FI capable wireless communication device could be used as a relay device and perform the process 3500 of FIG. 35.

Referring to FIG. 35, at step 3505 the relay device determines to perform a relay control action comprising (i) setup of a relay connection by which the relay device will relay traffic between the AP and the STA over the first and second links, (ii) teardown of the relay connection, or (iii) advertisement of a capability of the relay device to support the relay connection.

The relay device then generates a control message including an indication of the relay control action (step 3510).

The relay device then transmits, to at least one of the AP and the STA, the generated control message (step 3515).

In some embodiments, before determining to perform the relay control action, the relay device receives a relay setup request message from the AP or the STA and determines whether to set up the relay connection based on the relay setup request. The relay setup request message may include parameters for the relay connection, in which case the relay device determines whether to set up the relay connection based on whether the relay device can support the parameters. Based on the result of that determination, the indication of the relay control action in the generated control message is an indication that the relay setup request is either accepted or denied. In this case, the relay device may transmit the generated control message to the AP or the STA from which the relay setup request message was received.

In some embodiments, after the relay connection is set up between the AP and the STA, the relay device receives a relay teardown message from the AP or the STA, and stops relaying the traffic between the AP and the STA based on the relay teardown message.

In some embodiments, after the relay connection is set up between the AP and the STA, the relay device determines that it will stop relaying the traffic between the AP and the STA. In this case, the indication of the relay control action in the generated control message is an indication that the relay device will stop relaying the traffic between the AP and the STA.

In some embodiments, the relay device receives a relay capability advertisement message from the AP or the STA, and based on the relay capability advertisement message, the relay device prepares for a future request to set up the relay connection.

In some embodiments, the relay device determines parameters of relay connections that the relay device will support. In this case, the generated control message may include the determined parameters.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A wireless communication relay device comprising:
a transceiver configured to form a first link with a wireless access point (AP) and a second link with a wireless non-AP station (STA); and
a processor operably connected to the transceiver and configured to:
determine to perform a relay control action comprising (i) setup of a relay connection by which the relay device will relay traffic between the AP and the STA over the first and second links, (ii) teardown of the relay connection, or (iii) advertisement of a capability of the relay device to support the relay connection, and
generate a control message including an indication of the relay control action,
wherein the transceiver is further configured to transmit, to at least one of the AP and the STA, the generated control message.

2. The relay device of claim 1, wherein:
the transceiver is further configured to receive a relay setup request message from the AP or the STA,
the processor is further configured to determine whether to set up the relay connection based on the relay setup request,
based on the determination, the indication of the relay control action in the generated control message is an indication that the relay setup request is either accepted or denied, and
the transceiver is configured to transmit the generated control message to the AP or the STA from which the relay setup request message was received.

3. The relay device of claim 2, wherein:
the relay setup request message includes parameters for the relay connection, and
the processor is configured to determine whether to set up the relay connection based on whether the relay device can support the parameters.

4. The relay device of claim 1, wherein:
the transceiver is further configured to, after the relay connection is set up between the AP and the STA, receive a relay teardown message from the AP or the STA, and
the processor is further configured to stop relaying the traffic between the AP and the STA based on the relay teardown message.

5. The relay device of claim 1, wherein:
the processor is further configured to, after the relay connection is set up between the AP and the STA, determine that the relay device will stop relaying the traffic between the AP and the STA, and
the indication of the relay control action in the generated control message is an indication that the relay device will stop relaying the traffic between the AP and the STA.

6. The relay device of claim 1, wherein:
the transceiver is further configured to receive a relay capability advertisement message from the AP or the STA, and
the processor is further configured to, based on the relay capability advertisement message, prepare for a future request to set up the relay connection.

7. The relay device of claim 1, wherein:
the processor is further configured to determine parameters of relay connections that the relay device will support, and
the generated control message includes the determined parameters.

8. A method of wireless communication performed by a wireless communication relay device, the method comprising:
determining to perform a relay control action comprising (i) setup of a relay connection by which the relay device will relay traffic between a wireless access point (AP) and a wireless non-AP station (STA) over a first link with the AP and a second link with the STA, (ii) teardown of the relay connection, or (iii) advertisement of a capability of the relay device to support the relay connection;
generating a control message including an indication of the relay control action; and
transmitting, to at least one of the AP and the STA, the generated control message.

9. The method of claim 8, further comprising:
receiving a relay setup request message from the AP or the STA;
determining whether to set up the relay connection based on the relay setup request, wherein based on the determination, the indication of the relay control action in the generated control message is an indication that the relay setup request is either accepted or denied; and
transmitting the generated control message to the AP or the STA from which the relay setup request message was received.

10. The method of claim 9, wherein:
the relay setup request message includes parameters for the relay connection, and
the method further comprises determining whether to set up the relay connection based on whether the relay device can support the parameters.

11. The method of claim 8, further comprising:
after the relay connection is set up between the AP and the STA, receiving a relay teardown message from the AP or the STA; and
stopping relaying the traffic between the AP and the STA based on the relay teardown message.

12. The method of claim 8, further comprising:
after the relay connection is set up between the AP and the STA, determining that the relay device will stop relaying the traffic between the AP and the STA,
wherein the indication of the relay control action in the generated control message is an indication that the relay device will stop relaying the traffic between the AP and the STA.

13. The method of claim 8, further comprising:
receiving a relay capability advertisement message from the AP or the STA; and
based on the relay capability advertisement message, preparing for a future request to set up the relay connection.

14. The method of claim 8, further comprising:
determining parameters of relay connections that the relay device will support,
wherein the generated control message includes the determined parameters.

15. A wireless access point (AP) device comprising:
a transceiver configured to:
form a link with a wireless communication relay device, and
receive, from the relay device, a control message including an indication of a relay control action; and
a processor operably coupled to the transceiver, the processor configured to determine, from the control message, that the relay control action is one of (i) setup of a relay connection by which the relay device will relay traffic between the AP and a wireless non-AP station (STA) over the link, (ii) teardown of the relay connection, or (iii) advertisement of a capability of the relay device to support the relay connection.

16. The AP of claim 15, wherein:
the processor is further configured to generate a relay setup request message,
the transceiver is further configured to transmit the relay setup request message to the relay device, and
the indication of the relay control action in the control message is an indication that the relay setup request is either accepted or denied.

17. The AP of claim 16, wherein:
the relay setup request message includes parameters for the relay connection, and
the indication that the relay setup request is either accepted or denied is based on whether the relay device can support the parameters.

18. The AP of claim 15, wherein:
the processor is further configured to:
after the relay connection is set up, determine to stop relaying the traffic to the STA using the relay connection; and
generate a relay teardown message based on the determination, and
the transceiver is further configured to transmit the relay teardown message to the relay device.

19. The AP of claim 15, wherein:
the transceiver is further configured to, after the relay connection is set up, receive a relay teardown message from the relay device, and
the processor is further configured to stop relaying the traffic to the STA using the relay connection based on the relay teardown message.

20. The AP of claim 15, wherein:
the processor is further configured to generate a relay capability advertisement message based on a capability of the AP to support the relay connection, and
the transceiver is further configured to transmit the relay capability advertisement message to at least one of the relay device or the STA.
